(19) United States
(12) Patent Application Publication
(10) Pub. No.: US 2026/0166860 A1
(43) Pub. Date: Jun. 18, 2026

(54) SPECIAL PLASTIC FILM FOR THE PRODUCTION OF SECURITY DOCUMENTS

(71) Applicant: Covestro Deutschland AG, Leverkusen (DE)

(72) Inventors: Georgios Tziovaras, Neuss (DE); Heinz Pudleiner, Krefeld (DE); Helge Kosthorst, Visselhövede (DE)

(21) Appl. No.: 18/711,250

(22) PCT Filed: Nov. 25, 2022
(86) PCT No.: PCT/EP2022/083290

§ 371 Date: May 17, 2024

(30) Foreign Application Priority Data
Nov. 30, 2021 (EP) 21211268.4
Apr. 6, 2022 (EP) 22166920.3

(51) Int. Cl. B42D 25/29; B32B 27/08; B32B 27/32; B42D 25/328; B42D 25/387

(52) U.S. Cl. CPC B42D 25/29; B32B 27/08; B32B 27/32; B42D 25/328; B42D 25/387

(57) ABSTRACT

Provided is a security document (A) having a first outer surface (AS1) and a second outer surface (AS2) opposite the first outer surface (AS1) comprising at least: (A1) a first polymer film (A1), (A2) a second polymer film (A2), (A3) optionally at least one further polymer film (A3), (A4) a security feature (A4), (A5) optionally fibres, in particular structural fibres, wherein at least one of the polymer films selected from the group consisting of the first polymer film (A1), the second polymer film (A2), optionally the at least one further polymer film (A3) or a combination of at least two of these comprises a thermoplastic elastomer (TPE) or consists of at least one TPE and forms at least one of the outer surfaces (AS1) or (AS2) and to a process for producing such a security document and to the use thereof.

The present invention relates to a security document (A) comprising at least two polymer films (A1) and (A2), optionally further polymer films (A3), a security feature (A4), optionally fibres (A5), wherein at least the two outer surfaces of the security document are formed by a polymer which contains or consists of a thermoplastic elastomer (TPE).

Print substrates for value documents such as for example banknotes are subject to constant development to be able to meet the likewise ever increasing demands on durability, efficiency, forgery resistance and sustainability. To increase the service life of banknotes but also security documents such as passports there is an increasing trend for replacing security documents, especially banknotes, made of paper with banknotes made of polymer films. Banknotes based on plastic films contribute to the sustainability of the means of payment by increasing the service life of the banknotes or other security documents 2- to 3-fold and increasing the reusability of the material. The result of this is that markedly less in the way of energy, material and natural resources is needed for the production of banknotes and other security documents. In addition, the longer service life of the bank notes and other security documents makes it possible to achieve significant cost savings. Thus for example Australia introduced banknotes where a polymer film serves as the print substrate from 1988.

The production of banknotes from polymer films today employs almost exclusively films based on polyolefins which are biaxially oriented after extrusion (BOPP), as described in U.S. Pat. No. 5,879,028 A. As a consequence of the process these films can only be produced as transparent films. The films are subsequently coated to obtain a white opaque colour and to improve the printability of the film. In a few exceptions the production of banknotes employs composites of film with paper or other materials, for example cotton fibres, as described in WO06066431 A1. The outer paper layers form the alternative to the white coating of the BOPP films.

Having regard to forgery resistance, polymer banknotes made of BOPP have several substantial disadvantages compared to banknotes made of security papers. It is especially impossible to incorporate features used in paper substrates and recognized by the consumer such as flecking fibres (these are also added to stamps for forgery resistance and are visible as small, red-glowing fibres under UV light), planchettes (incorporated coloured discs similar to flecking fibres. Planchettes may also be metallic or transparent; they can also fluoresce under UV light or be made of iridescent material that exhibits colour change. Special planchettes for use in driver's licenses react to manipulation attempts by bleeding a signal colour) or security threads in polymer banknotes made of BOPP because these are destroyed after the stretching of the film in the longitudinal and transverse direction.

A further disadvantage is the fact that BOPP is a polymer that is used in similar quality in countless products of everyday use such as packaging films, transparent films, sealing films etc. and is therefore readily available for imitations to a potential forger. The fact that the employed substrate is a stretched film is disadvantageous especially when the substrate is exposed to elevated temperatures such as may readily occur in everyday use.

Biaxially stretched polypropylene exhibits very high shrinkage at higher temperatures. Thus for example at a temperature above about 100° C. a polymer banknote made of biaxially stretched polypropylene was found to undergo shrinkage in length and width of up to 20% of its original length and width. These polymer banknotes also undergo different degrees of shrinkage in length and width thus leading to distortion of the banknote and thus of the print image generally applied thereto. A further disadvantage of the polymer banknotes known hitherto, in particular the polymer banknotes based on biaxially stretched polyolefins, is that the above-described shrinkage is irreversible. In the vicinity of a hot stove top or else under a halogen lamp it is quite possible for such a polymer banknote to undergo irreversible shrinkage.

Complex and cost-intensive production processes are necessary, especially to achieve the desired opacity of the film and also the necessary surface energy to allow the take-up of printing inks. The tear propagation resistance is also particularly low for BOPP films. A minimal tear in the banknote will result in immediate failure of the banknote.

Both polyolefin-based films and composite films exhibit the abovementioned disadvantages and there is therefore a need to minimize or even eliminate these disadvantages.

It is an object of the present invention to develop a process of the type in question and a polymer print substrate of the type in question, for example in the form of a security element, such as a banknote or a passport, in such a way that the disadvantages of the prior art are at least partly overcome, in particular to increase the forgery resistance of the security document.

It is a further object of the invention to provide a security document which meets the present demands on durability, efficiency, in particular resource efficiency, forgery resistance and sustainability while in particular meeting none of these demands less well than is the case in the present prior art.

It is a further object of the invention to provide a security document which has a sufficient surface energy to allow take-up of printing inks.

It is a further object of the invention to provide an optimized, in particular more cost-effective, process for a security document having the recited advantages.

A first aspect of the invention is a security document (A) having a first outer surface (AS1) and a second outer surface (AS2) opposite the first outer surface (AS1) comprising at least:
(A1) a first polymer film (A1),
(A2) a second polymer film (A2),
(A3) optionally at least one further polymer film (A3),
(A4) a security feature (A4),
(A5) optionally fibres, in particular structural fibres,
   wherein at least one of the polymer films selected from the group consisting of the first polymer film (A1), the second polymer film (A2), optionally the at least one further polymer film (A3) or a combination of at least two of these comprises a thermoplastic elastomer (TPE) or consists of at least one TPE and forms at least one of the outer surfaces (AS1) or (AS2).

The security document may have any shape that a person skilled in the art would select for a security document. It is preferable when the security document has a sheetlike extent in the form of a square, a rectangle, a circle, an oval or a polyhedron, particularly preferably in the form of a square or a rectangle.

The security document preferably has a thickness in a range from 40 to 250 μm, more preferably in a range from 50 to 200 μm, more preferably in a range from 60 to 150 μm, more preferably in a range from 70 to 100 μm.

The aspect ratio between the thickness of the security document and its area is preferably in a range from 1:100 000 to 1:1000, more preferably in a range from 1:50 000 to 1:500, particularly preferably in a range from 1:10 000 to 1:100.

The first polymer film (A1) preferably has a thickness in a range from 10 to 100 μm, more preferably in a range from 12 to 90 μm, more preferably in a range from 15 to 50 μm, more preferably in a range from 20 to 40 μm.

The second polymer film (A2) preferably has a thickness in a range from 20 to 150 μm, more preferably in a range from 30 to 100 μm, more preferably in a range from 40 to 90 μm, more preferably in a range from 50 to 80 μm.

The further polymer film (A3) preferably has a thickness in a range from 10 to 100 μm, more preferably in a range from 12 to 90 μm, more preferably in a range from 15 to 50 μm, more preferably in a range from 20 to 40 μm.

At least one polymer film selected from the group consisting of the first polymer film (A1), (A2) and (A3) in each case preferably has a length in a range from 1 to 100 cm, more preferably in a range from 2 to 80 cm, particularly preferably in a range from 5 to 50 cm.

At least one polymer film selected from the group consisting of the first polymer film (A1), (A2) and (A3) in each case preferably has a width in a range from 1 to 100 cm, more preferably in a range from 2 to 80 cm, particularly preferably in a range from 5 to 50 cm.

It is preferable when the polymer films (A1) and (A2) and preferably also (A3) are superposed in their areal extent.

The security document (A) may be any security document that a person skilled in the art would use for introduction of a security feature. The security document (A) is preferably selected from the group consisting of a banknote, a birth certificate, a stamp, a tax stamp, a visa page of a passport, a hinge for the data page of a passport, a carrier layer of an electromagnetic shield in a passport or a combination of at least two of these.

Both outer surfaces (AS1) and (AS2) preferably comprise a TPE. Both outer surfaces (AS1) and (AS2) preferably consist of a TPE. Both outer surfaces (AS1) and (AS2) are preferably each formed by a polymer film (A1). It is further preferable when the polymer film (A2) forms the core of an at least trilayer film structure in which the outer surfaces (AS1) and (AS2) are each formed by a polymer film (A1).

It is preferable when at least one of the polymer films (A1), (A2) and optionally (A3), in particular the first polymer film (A1), comprises a material which is suitable for building up an adhesive strength to the respective adjacent polymer film, i.e. the second polymer film (A2) or the further polymer film (A3), which is greater than the breaking elongation of at least one of the polymer films (A1), (A2) or (A3). The adhesive strength is higher than the breaking stress of the respective polymer film if one of the polymer films (A1), (A2) or (A3) cannot be separated residual-free from the respective adjacent polymer film. This is to be understood as meaning that that when separating the first polymer film (A1) from the second polymer film (A2) or the second polymer film (A2) from the further polymer film (A3) at least one of the polymer films (A1), (A2) or (A3) suffers a cohesive failure and not an adhesive failure where the adhesive force would be less than the breaking stress of the polymer films. In contrast to an adhesive failure which would represent a separation of the security document (A) at the adhesive surface between the respective films and would allow residual-free separation of the films from one another, cohesive failure occurs inside the layer and leaves residues of the polymer material on the respective film that is to be separated.

This sufficiently high adhesive force thus contributes to the forgery resistance of the security document (A).

It is preferable when the polymer films (A1), (A2) and optionally (A3) have an adhesive strength to their respectively adjacent polymer film of at least 2 N/cm, more preferably of at least 3 N/cm, particularly preferably of at least 5 N/cm. It is preferable when the polymer films (A1), (A2) and optionally (A3) have an adhesive strength to their respectively adjacent polymer film in a range from 2 to 20 N/cm, more preferably of at least 3 N/cm to 15 N/cm, particularly preferably of at least 5 N/cm to 10 N/cm, measured according to ASTM D903-1998 at a tensile angle of 180°.

The fibres (A5) are preferably structural fibres. A structural fibre is a fibre that strengthens the surrounding material in its structure, especially in properties such as brittleness and flexibility. It is preferable when the material of the fibres (A5) is selected from the group consisting of a glass fibre, a carbon fibre, a silicone fibre, mineral fibre, a natural fibre such as hemp fibre or bamboo fibre, or a combination of at least two of these. It is preferable when the security document (A) comprises the fibres (A5) in an amount in a range from 0.1% to 10% by weight, more preferably in a range from 0.2% to 8% by weight, particularly preferably in a range from 0.5% to 5% by weight, based on the total weight of the security document (A). It is preferable when the first polymer film (A1) or the second polymer film (A2) independently of one another comprises the fibres (A5) in an amount in a range from 0.1% to 15% by weight, more preferably in a range from 0.2% to 10% by weight, particularly preferably in a range from 0.5% to 8% by weight, based on the total weight of the security document (A).

It is preferable when the security document (A) comprises an embossing. The embossing is preferably a security feature (A4). It is preferable when at least a portion of the at least one security feature (A4) is introduced as an embossing (P) in one of the polymer films (A1), optionally (A2) or (A3) containing or consisting of TPE.

It is preferable when the embossing (P) has a resolution of at least 1500 dpi, preferably in a range from 1500 to 2500 dpi. It is preferable when the lines of the embossing (P) have a width in a range from 100 to 1000 μm, particularly preferably from 110 to 500 μm, very particularly preferably from 120 to 200 μm. It is preferable when the lines of the embossing (P) have a depth in a range from 50 to 500 μm, particularly preferably from 55 to 300 μm, very particularly preferably from 60 to 100 μm.

The embossing (P) is preferably introduced into the outer surface (AS1) or (AS2) of the security document (A) to ensure that it is visible and feelable from the outside. The contour of the embossing (P) preferably extends outwards. Alternatively or in addition the embossing (P) may also be introduced on an inner surface, for example on one of the inner surfaces of a passport. In order for the embossing (P) to afford the effect of a security feature the embossing (P) should be introduced in such a way that the observer can detect and preferably also feel it when inspecting the security document (A).

In a preferred embodiment of the security document (A) the TPE has a hardness in a range from 45 Shore D to 95 Shore D, preferably in a range from 50 Shore D to 85 Shore D.

It is preferable when the polymer films (A1) arranged on the outer surfaces (AS1) and (AS2) of the security document (A) comprise a TPE having a hardness in a range from 45 Shore D to 85 Shore D, preferably in a range from 50 Shore D to 80 Shore D, very particularly preferably from 55 Shore D to 70 Shore D.

It is preferable when the at least one polymer film (A2) which is preferably arranged in the core of the security document (A) and is preferably surrounded on each side by at least one polymer film (A1) comprises a TPE having a hardness in a range from 55 Shore D to 95 Shore D, preferably in a range from 65 Shore D to 90 Shore D, very particularly preferably from 70 Shore D to 85 Shore D.

In a preferred embodiment of the security document (A) the TPE is selected from the group consisting of a copolyester elastomer (TPC), a thermoplastic polyamide elastomer (TPA), in particular a polyether block amide (PEBA), an olefin-based thermoplastic elastomer (TPO), in particular PP/EPDM, a thermoplastic polyurethane (TPU), a thermoplastic polycarbonate (PC), a polyethylene terephthalate (PET), in particular a polyethylene terephthalate glycol (PETG), a thermoplastic styrene block copolymer (TPS), in particular styrene-butadiene block copolymer (SBC), or a mixture of at least two of these. TPEs are elastomers which behave like classical representatives of elastomers at room temperature but become deformable upon heating. These are usually copolymers composed of a soft elastomer component and a hard thermoplastic component.

Suitable copolyester elastomers TPC (segmented polyester elastomers), hereinafter also referred to simply as copolyesters, are formed for example from a plurality of repeating short-chain ester units and long-chain ester units joined by ester bonds, wherein the short-chain ester units account for about 15-80% by weight of the copolyester and conform to formula (I):

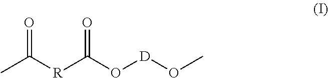

in which
R is a divalent radical of a dicarboxylic acid which has a molecular weight of less than about 350 g/mol,
D is a divalent radical of an organic diol which has a molecular weight of less than about 250 g/mol,
   the long-chain ester units account for about 20% to 85% by weight, preferably 30% to 70% by weight, particularly preferably 35% to 60% by weight, of the copolyester and preferably conform to formula II:

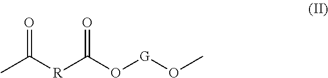

in which
R is a divalent radical of a dicarboxylic acid which has a molecular weight of less than about 350 g/mol,
G is a divalent radical of a long-chain glycol which has an average molecular weight of about 350 to 6000 g/mol.

The employable copolyesters may be produced by copolymerizing a) one or more dicarboxylic acids, b) one or more linear, long-chain glycols and c) one or more low molecular weight diols.

The dicarboxylic acids for the production of the copolyester are aromatic acids having 8-16 carbon atoms, in particular phenylenedicarboxylic acids such as phthalic, terephthalic and isophthalic acid.

The low molecular weight diols for the reaction to form the short-chain ester units of the copolyesters belong to the classes of acyclic, alicyclic and aromatic dihydroxy compounds. The preferred diols have 2-15 carbon atoms, such as ethylene, propylene, tetramethylene, isobutylene, pentamethylene, 2,2-dimethyltrimethylene, hexamethylene and decamethylene glycols, dihydroxycyclohexane, cyclohexanedimethanol, resorcinol, hydroquinone and the like. Bisphenols for the present purpose include bis(p-hydroxy)diphenyl, bis(p-hydroxyphenyl)methane, bis(p-hydroxyphenyl)ethane and bis(p-hydroxyphenyl)propane.

The long-chain glycols used to produce the soft segments of the copolyesters preferably have molecular weights of about 600 to 3000 g/mol. These include poly(alkylene ether) glycols in which the alkylene groups have 2-9 carbon atoms.

Glycol esters of poly(alkylene oxide)dicarboxylic acids or polyester glycols can also be used as long-chain glycol.

The long-chain glycols also include polyformals, which are obtained by reacting formaldehyde with glycols. Polythioether glycols are also suitable. Polybutadiene glycols and polyisoprene glycols, copolymers of the same, and saturated hydrogenation products of these materials are satisfactory long-chain polymeric glycols.

Processes for synthesizing such copolyesters are known from DE-A 2 239 271, DE-A 2 213 128, DE-A 2 449 343 and U.S. Pat. No. 3,023,192. Examples of suitable TPC include the polyether elastomers Hytrel® from DuPont™ (Germany) and the polyether elastomers Keyflex® from LG Chemicals (Europe), preferably representatives thereof having a hardness in the range from 45 to 95 Shore D.

The thermoplastic polyamide elastomer (TPA) may be any TPA that a person skilled in the art would select for this purpose. The TPA is preferably a polyether block amide (PEBA). Suitable PEBAs are for example those consisting of polymer chains formed from repeating units conforming to formula (III)

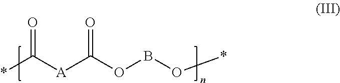

in which
A is the polyamide chain derived from a polyamide having 2 carboxyl end groups via the loss of the latter and
B is the polyoxyalkylene glycol chain derived from a polyoxyalkylene glycol having terminal OH groups via the loss of the latter, and
n is the number of units forming the polymer chain. The end groups here are preferably OH groups or radicals of compounds which terminate the polymerization.

The dicarboxylic polyamides having the terminal carboxyl groups are obtained in a known manner, for example by polycondensation of one or more lactams and/or one or more amino acids, or else by polycondensation of a dicarboxylic acid with a diamine, in each case in the presence of an excess of an organic dicarboxylic acid preferably having terminal carboxyl groups. These carboxylic acids become constituents of the polyamide chain during the polycondensation and undergo addition especially onto the ends of said chain, thus affording a polyamide having μ-dicarboxylic acid functionality. The dicarboxylic acid also acts as a chain terminator, which is why it is also used in excess.

The polyamide can be obtained from lactams and/or amino acids having a hydrocarbon chain consisting of 4-14 carbon atoms, for example from caprolactam, enantholactam, dodecalactam, undecanolactam, decanolactam, 11-aminoundecanoic or 12-aminododecanoic acid.

Examples of polyamides, such as are formed by polycondensation of a dicarboxylic acid with a diamine, include the condensation products of hexamethylenediamine with adipic acid, azelaic acid, sebacic acid and 1,12-dodecanedioic acid, and the condensation products of nonamethylenediamine and adipic acid, preferably representatives thereof having a hardness in the range from 45 to 95 Shore D.

Suitable dicarboxylic acids for the synthesis of the polyamide, employed both for fixing one carboxyl group to each end of the polyamide chain and as chain terminator, include those having 4-20 carbon atoms, in particular alkanedioic acids, such as succinic acid, adipic acid, suberic acid, azelaic acid, sebacic acid, undecanedioic acid or dodecanedioic acid, and additionally cycloaliphatic or aromatic dicarboxylic acids such as terephthalic acid or isophthalic acid or cyclohexane-1,4-dicarboxylic acid.

The polyoxyalkylene glycols having terminal OH groups are unbranched or branched and comprise an alkylene radical having at least 2 carbon atoms. These are preferably polyoxyethylene, polyoxypropylene and polyoxytetramethylene glycol, as well as copolymers thereof.

The average molecular weight of these OH-terminated polyoxyalkylene glycols may vary over a wide range and is advantageously between 100 and 6000 g/mol, in particular between 200 and 3000 g/mol.

The weight fraction of the polyoxyalkylene glycol, based on the total weight of the polyoxyalkylene glycol and dicarboxylic polyamide used to produce the PEBA polymer, is 5-85% by weight, preferably 10-50% by weight.

Processes for synthesizing such PEBA polymers are known from FR Patent 7 418 913, DE-A 28 02 989, DE-A 28 37 687, DE-A 25 23 991, EP-A 095 893, DE-A 27 12 987 and DE-A 27 16 004.

PEBA polymers which, in contrast to those described above, have a random structure are preferentially suitable. To produce these polymers a mixture of:
1. one or more polyamide-forming compounds from the group of aminocarboxylic acids or lactams having at least 10 carbon atoms,
2. an α,ω-dihydroxypolyoxyalkylene glycol,
3. at least one organic dicarboxylic acid
   in a 1:(2+3) weight ratio of between 30:70 and 98:2, wherein hydroxyl groups and carbonyl groups are present in equivalent amounts in (2+3), is heated to temperatures of between 23° C. and 30° C. in the presence of 2% to 30% by weight of water based on the polyamide-forming compounds of group 1. under autogenous pressure and subsequently after removal of the water subjected to further treatment at 250° C. to 280° C. at standard pressure or under reduced pressure in the absence of oxygen.

The TPO may be any TPO that a person skilled in the art would select for a security document (A) according to the invention. Examples of TPO are thermoplastic olefins of the product line KEYFLEX® from LG Chemicals (Europe), such as KEYFFLEX® TP-1045D. The TPO is preferably a PP/EPDM. Examples of these TPO types are Santoprene™ from Advanced Elastomer Systems Ltd., a subsidiary of ExxonMobil Chemical Europe (Belgium), Saxomer® TPE-O from PCW GmbH (Germany), Elastron TPO from Elastron (Turkey/Germany), preferably representatives thereof having a hardness in the range from 45 to 95 Shore D.

The thermoplastic polyurethane (TPU) may be any TPU that a person skilled in the art would select for the security document (A) according to the invention.

A preferred process for producing thermoplastically processable polyurethane polymers is one that comprises reacting the components
(A) one or more substantially linear polyols, wherein the total amount of component (A) has an average molecular weight in the range from 500 g/mol to 5000 g/mol,
(B) one or more organic polyisocyanates, preferably organic diisocyanates,
(C) one or more linear diols having a molecular weight of 62 g/mol to 500 g/mol,
(D) optionally in the presence of one or more catalysts,
(E) optionally in the presence of one or more additives, auxiliary and/or additive substances and
(F) optionally in the presence of one or more monofunctional chain terminators,
   wherein the process preferably comprises or consists of the following steps:
1) providing and reacting a mixture composed of the total amount of component (A), a subamount of component (B) and optionally a subamount or the total amount of component (D), component (E) and/or component (F) to afford an NCO-functional prepolymer, wherein in process step 1) a molar ratio of component (B) to component (A) is in the range from 1.1:1.0 to 5.0:1.0,
2) reacting the NCO-functional prepolymer from process step 1) with the total amount of component (C) to obtain an OH-functional prepolymer, optionally in the presence of a further subamount of component (D), component (E) and/or component (F),
3) reacting the OH-functional prepolymer with the remaining amount of component (B) and any remaining amount of component (D), component (E) and/or component (F) to obtain the thermoplastically processable polyurethane, wherein over all process steps a molar ratio of component (B) to the sum of component (A) and component (C) is in the range from 0.9:1.0 to 1.2:1.0.

The preferred process makes it possible to produce thermoplastic polyurethanes having good processing properties and good mechanical properties over a hardness range from about 45 Shore D to about 95 Shore D and to achieve good coupling of the hard and soft phases of the TPU, thus resulting in an optimally high molecular weight and thus in very good mechanical properties of the manufactured workpieces.

In the context of the present invention the word “a” in association with countable parameters is to be understood as the number “one” only when this is stated explicitly (for instance by the expression “precisely one”). Where reference is made hereinbelow for example to “a polyol” the word “a” is to be understood as meaning merely the indefinite article and not the number “one” and this therefore also encompasses an embodiment comprising a mixture of at least two polyols.

“Substantially” in this context is to be understood as meaning that at least 95 mol %, preferably at least 98 mol %, particularly preferably at least 99 mol %, yet more preferably at least 99.5 mol %, yet more preferably at least 99.8 mol % and most preferably 100 mol % of the total amount of substance of the polyols of component A) consists of linear polyols.

The hardness of the thermoplastically processable polyurethanes may be adjusted from 45 Shore D to 95 Shore D by selecting the molar ratio of component A) to component C).

The amounts of the reaction components for the NCO-functional prepolymer formation in step 1) are selected such that the NCO/OH ratio of polyisocyanate to polyol in step 1) is from 1.1:1 to 5.0:1.

The components are intimately mixed and the NCO prepolymer reaction in step 1) is preferably brought to complete conversion (based on the polyol component).

This is followed by incorporation of at least component (C) as chain extender (step 2) to afford a substantially OH-functional prepolymer.

Subsequently, in step 3), the residual amount of component (B) is added while maintaining an NCO/OH ratio of 0.9:1 to 1.2:1. It is preferable when step 3) employs the same component (B) as step 1).

It is preferable when process step 2) is carried out with a molar ratio of NCO-functional prepolymer to component (C) of less than 1.0. Component (C) is thus present in a molar excess.

Suitable components (A) include all linear polyols known to those skilled in the art and having an average molecular weight of greater than 500 g/mol. Suitable components (A) especially include the following linear polyols: a) polyester polyols, b) polyether polyols, c) polyether esters, d) polycarbonate polyols, e) polyether carbonates, or mixtures of at least two of the polyols a) to e).

Suitable polyester diols a) can be prepared, for example, from dicarboxylic acids having 2 to 12 carbon atoms, preferably 2 to 6 carbon atoms, and polyhydric alcohols. Examples of useful dicarboxylic acids include: aliphatic dicarboxylic acids such as succinic acid, glutaric acid, adipic acid, suberic acid, azelaic acid and sebacic acid, dodecanedioic acid and aromatic dicarboxylic acids such as phthalic acid, isophthalic acid and terephthalic acid. The dicarboxylic acids may be used individually or as mixtures, for example in the form of a succinic, glutaric and adipic acid mixture. For preparation of the polyester polyols, it may in some cases be advantageous to use, rather than the dicarboxylic acids, the corresponding dicarboxylic acid derivatives such as carboxylic diesters having 1 to 4 carbon atoms in the alcohol radical, carboxylic anhydrides or carbonyl chlorides. Examples of polyhydric alcohols are glycols having 2 to 12 and preferably 2 to 6 carbon atoms, such as ethylene glycol, diethylene glycol, butane-1,4-diol, pentane-1,5-diol, hexane-1,6-diol, decane-1,10-diol, dodecane-1,12-diol, 2,2-dimethylpropane-1,3-diol, propane-1,3-diol, propane-1,2-diol and dipropylene glycol. Depending on the desired properties, the polyhydric alcohols may be used alone or optionally in a mixture with one another. Also suitable are condensation products of hydroxycarboxylic acids, for example hydroxycaproic acid, and polymerization products of lactones, for example optionally substituted caprolactones. Polyester polyols used with preference are ethanediol polyadipates, butane-1,4-diol polyadipates, hexane-1,6-diol polyadipates, ethanediol butane-1,4-diol polyadipates, hexane-1,6-diol neopentyl glycol polyadipates, hexane-1,6-diol butane-1,4-diol polyadipates and polycaprolactones. The polyester diols have molecular weights in the range from 500 to 5000 g/mol, preferably in the range from 600 to 3500 g/mol and particularly preferably in the range from 800 to 3000 g/mol. They may be used singly or in the form of mixtures with one another.

Suitable polyether diols b) may be prepared by reacting one or more alkylene oxides having 2 to 4 carbon atoms in the alkylene radical with a starter molecule containing two active hydrogen atoms in bonded form. Examples of alkylene oxides include: ethylene oxide, 1,2-propylene oxide, epichlorohydrin and 1,2-butylene oxide and 2,3-butylene oxide. Preference is given to using ethylene oxide, propylene oxide and mixtures of 1,2-propylene oxide and ethylene oxide. The alkylene oxides may be used individually, alternately in succession or as mixtures. Examples of contemplated starter molecules include: water, amino alcohols such as N-alkyldiethanolamines, for example N-methyldiethanolamine, and diols such as ethylene glycol, 1,3-propylene glycol, butane-1,4-diol and hexane-1,6-diol. It is also optionally possible to use mixtures of starter molecules. Other suitable polyether diols are the hydroxyl group-containing polymerization products of tetrahydrofuran. It is also possible to use trifunctional polyethers in proportions of 0 to 30% by weight based on the bifunctional polyethers but at most in an amount such that a thermoplastically processable product is formed. Suitable polyether diols have a number-average molecular weight M. of 500 to 5000 g/mol, preferably 750 to 5000 g/mol and very particularly preferably 900 to 4200 g/mol. They may be used either individually or else in the form of mixtures with one another.

Suitable polyether esters c) may be prepared for example by reaction of short-chain polyether diols, for example polytetrahydrofurans having molecular weights of 250 to 1000 g/mol, with organic dicarboxylic acids, for example succinic acid or adipic acid. The polyether ester diols have molecular weights of 600 to 5000 g/mol, preferably 700 to 4000 g/mol and particularly preferably 800 to 3000 g/mol. They may be used singly or in the form of mixtures with one another.

Suitable polycarbonate diols d) may be prepared for example by reaction of short-chain diols, for example butane-1,4-diol or hexane-1,6-diol, with diphenyl carbonate or dimethyl carbonate with the assistance of catalysts and with elimination of phenol or methanol. The polycarbonate diols have a number-average molecular weight of from 500 g/mol to 5000 g/mol, preferably from 750 to 5000 g/mol and particularly preferably from 1000 to 4500 g/mol.

Suitable polyether carbonate diols e) can be prepared, for example, by reaction of short-chain polyether diols such as polytetrahydrofurans having molecular weights of 250 to 1000 g/mol with diphenyl or dimethyl carbonate with the assistance of catalysts and with elimination of phenol or methanol. Polyether carbonate diols may moreover be prepared by copolymerization of alkylene oxides, e.g. ethylene oxide or propylene oxide or mixtures thereof, with carbon dioxide with the aid of suitable catalysts, e.g. double metal cyanide catalysts. The polyether carbonate diols have a number-average molecular weight of 500 to 8000 g/mol, preferably 750 to 6000 g/mol and more preferably 1000 to 4500 g/mol.

Preferred organic polyisocyanates of component (B) which are employed in steps 1) and 3) are aliphatic, cycloaliphatic, araliphatic, heterocyclic and aromatic polyisocyanates, such as are described in Justus Liebigs Annalen der Chemie, 562, p. 75-136.

Specific examples include: aliphatic diisocyanates, such as 1,6-hexamethylene diisocyanate, cycloaliphatic diisocyanates, such as isophorone diisocyanate, 1,4-cyclohexane diisocyanate, 1-methyl-2,4-cyclohexane diisocyanate and 1-methyl-2,6-cyclohexane diisocyanate and also the corresponding isomer mixtures, 4,4′-dicyclohexylmethane diisocyanate, 2,4′-dicyclohexylmethane diisocyanate and 2,2′-dicyclohexylmethane diisocyanate and also the corresponding isomer mixtures, aromatic diisocyanates, such as 2,4-tolylene diisocyanate, mixtures of 2,4-tolylene diisocyanate and 2,6-tolylene diisocyanate, 4,4′-diphenylmethane diisocyanate, 2,4′-diphenylmethane diisocyanate and 2,2′-diphenylmethane diisocyanate, mixtures of 2,4′-diphenylmethane diisocyanate and 4,4′-diphenylmethane diisocyanate, urethane-modified liquid 4,4′-diphenylmethane diisocyanates and 2,4′-diphenylmethane diisocyanates, 4,4′-diisocyanato-1,2-diphenylethane and 1,5-naphthylene diisocyanate. Preferably employed are 1,6-hexamethylene diisocyanate, isophorone diisocyanate, 4,4′-dicyclohexylmethane diisocyanate, diphenylmethane diisocyanate isomer mixtures having a 4,4′-diphenylmethane diisocyanate content of >96% by weight and especially 4,4′-diphenylmethane diisocyanate and 1,5-naphthylene diisocyanate. These diisocyanates may be used singly or in the form of mixtures with one another. They may also be used together with up to 15% by weight (based on the total amount of diisocyanate) of a polyisocyanate, for example triphenylmethane 4,4′,4″-triisocyanate or polyphenylpolymethylene polyisocyanates.

It is preferable when component (B) employed is a diphenylmethane diisocyanate isomer mixture having a 4,4′-diphenylmethane diisocyanate content of more than 96% by weight based on the total weight of component (B), preferably is 4,4′-diphenylmethane diisocyanate.

Component (B) employed is preferably 1,6-hexamethylene diisocyanate.

Suitable components (C) (chain extender) include all linear diols known to those skilled in the art and having a molecular weight of 62 g/mol to 500 g/mol. The diols and/or their precursor compounds may have been obtained from fossil or biological sources. Suitable diols are preferably aliphatic diols having 2 to 14 carbon atoms, such as for example ethanediol, butane-1,4-diol, hexane-1,6-diol, octane-1,8-diol, decane-1,10-diol, dodecane-1,12-diol, diethylene glycol and dipropylene glycol. However, also suitable are diesters of terephthalic acid with glycols having 2 to 4 carbon atoms, such as for example terephthalic acid bis-ethylene glycol or terephthalic acid bis-butane-1,4-diol, hydroxyalkylene ethers of hydroquinone, such as for example 1,4-di(hydroxyethyl)hydroquinone and ethoxylated bisphenols. Particular preference is given to using ethanediol, butane-1,4-diol, hexane-1,6-diol and 1,4-di(hydroxyethyl)hydroquinone as short-chain diols. Mixtures of the abovementioned chain extenders may also be used. It is also possible to add small quantities of diamines and/or triols.

It is preferable when component (C) employed is one or more diols selected from the group consisting of ethane-1,2-diol, butane-1,4-diol, hexane-1,6-diol, 1,4-di(beta-hydroxyethyl)hydroquinone or a mixture of at least two of these, preferably ethane-1,2-diol, butane-1,4-diol or mixtures thereof and particularly preferably ethane-1,2-diol is used as component (C).

Catalysts (D) that may be used include the customary catalysts known from polyurethane chemistry. Suitable catalysts include customary tertiary amines known per se, for example triethylamine, dimethylcyclohexylamine, N-methylmorpholine, N,N′-dimethylpiperazine, 2-(dimethylaminoethoxy)ethanol, diazabicyclo[2.2.2]octane and the like and especially also organometallic compounds such as titanate esters, iron compounds, bismuth compounds, tin compounds, for example tin diacetate, tin dioctoate, tin dilaurate or the dialkyltin salts of aliphatic carboxylic acids such as dibutyltin diacetate, dibutyltin dilaurate or the like. Preferred catalysts are organometallic compounds, in particular titanate esters, iron compounds or tin compounds. Very particular preference is given to dibutyltin dilaurate, tin dioctoate and titanate esters.

Further details and preferred embodiments of the production process for suitable TPUs may be found in EP 3 838 961 A.

It is preferable when the TPE comprises a thermoplastic polyurethane (TPU) preferably produced by the above-described process in a range from 10% to 100% by weight, more preferably in a range from 20% to 95% by weight, more preferably in a range from 30% to 90% by weight, particularly preferably in a range from 40% to 85% by weight, based on the total weight of the TPE.

The polymer film (A1) preferably comprises a TPU having a Shore D hardness in a range from 45 to 85 Shore D, preferably in a range from 50 to 80 Shore D, very particularly preferably from 55 to 70 Shore D. The polymer film (A1) preferably comprises the TPU, preferably produced by the above-described process, in a range from 10% to 100% by weight, more preferably in a range from 20% to 95% by weight, based on the total weight of the polymer film (A1).

The polymer film (A2) preferably comprises a TPU having a hardness in a range from 55 to 95 Shore D, preferably in a range from 65 to 90 Shore D, very particularly preferably from 70 to 85 Shore D. The polymer film (A2) preferably comprises the TPU, preferably produced by the above-described process, in a range from 10% to 100% by weight, more preferably in a range from 20% to 95% by weight, based on the total weight of the polymer film (A2).

Examples of TPU types that are suitable for polymer film (A1) and polymer film (A2) include: Estane® from Lubrizol, Elastollan® from BASF AG (Germany), Desmopan® from Covestro Deutschland AG (Germany), preferably those having a hardness of 45 to 95 Shore D.

The thermoplastic polycarbonate (PC) may be any elastomeric PC that a person skilled in the art would select for this purpose. The PC is preferably produced according to the polycarbonates described in WO 2018/11436 A1, in particular the polycarbonate blends such as are described on page 3, last paragraph to page 16, third paragraph.

The polyethylene terephthalate (PET) may be any PET that a person skilled in the art would employ for the security document (A) according to the invention. The PET is preferably a polyethylene terephthalate glycol (PETG), for example Eastar® from EASTMAN Chemical GmbH (Germany).

The thermoplastic styrene block copolymer (TPS) may be any styrene block copolymer that a person skilled in the art would employ for the security document (A) according to the invention. Preferred TPS are styrene-ethylene-butylene-styrene block copolymer (SEBS), styrene-ethylene-propylene-styrene block copolymer (SEPS), styrene-isoprene-styrene block copolymer (SIS), styrene-ethylene-ethylene-butadiene-styrene (SEEPS) and methyl methacrylate-butadiene-styrene (MBS). Examples of SBS product lines include Styroflex® from BASF AG (Germany) and THERMOLAST® from Kraiburg Holding (Germany). Examples of SBES product lines include Saxomer® TPE-S from PCW GmbH (Germany), preferably representatives thereof having a hardness of 45 to 95 Shore D.

The TPE preferably contains the additives customary for plastics. Examples of typical additives are lubricants, such as fatty acid esters, metal soaps thereof, fatty acid amides and silicone compounds, antiblocking agents, inhibitors, stabilizers against hydrolysis, light, heat and discolouration, flame retardants, dyes, pigments, inorganic or organic fillers, and reinforcers. Further information about the recited auxiliary and additive substances may be found in the specialist literature, for example J. H. Saunders, K. C. Frisch: “High Polymers”, volume XVI, Polyurethane, part 1 and 2, Interscience Publishers 1962 and 1964, R. Gächter, H. Müller (Ed.): Taschenbuch der Kunststoff-Additive, 3rd edition, Hanser Verlag, Munich 1989, or DE-A 29 01 774.

In a preferred embodiment of the security document (A) the outer surfaces (AS1) and (AS2) of the security document (A) consist of a polymer film (A1), (A2) or (A3) comprising or consisting of a TPU.

It is preferable when the first polymer film (A1) forms the first outer surface (AS1) and preferably also outer surface (AS2) of the security document (A). It is preferable when the second polymer film (A2) forms the core of the security document (A).

In a preferred embodiment of the security document (A) at least all polymer films (A1), (A2) and optionally (A3) consist exclusively of polymers. It is preferable when all polymer films (A1), (A2) and optionally (A3) consist of a TPE. It is very particularly preferable when all polymer films (A1), (A2) and optionally (A3) consist of a mutually independently selected TPU. It is preferable when the complete security document (A) consists of polymers with the exception of the security feature (A4) and the fibres (A5).

In a preferred embodiment of the security document (A) at least one of the polymer films selected from the group consisting of the first polymer film (A1), the second polymer film (A2) or both comprises the TPE in an amount in a range from 50% to 100% by weight, preferably from 60% to 90% by weight, particularly preferably from 70% to 80% by weight, based on the total weight of the respective polymer film (A1) or (A2). It is particularly preferable when polymer film (A1) consists of a TPE. It is particularly preferable when polymer film (A2) consists of a TPE.

In a preferred embodiment of the security document (A) at least one of the polymer films selected from the group consisting of the first polymer film (A1), the second polymer film (A2) or both polymer films (A1) and (A2) comprise a polymer selected from the group consisting of a thermoplastic polyurethane (TPU), a copolyester or a mixture of at least two of these or mixtures of TPU and further TPEs in an amount in a range from 50% to 100% by weight, preferably from 60% to 90% by weight, particularly preferably from 70% to 80% by weight, based on the total weight of the respective polymer film (A1) or (A2).

In a preferred embodiment of the security document (A) the security document (A) comprises at least one further polymer film (A3), wherein the at least one further polymer film (A3) comprises the TPE in an amount in a range from 50% to 100% by weight, preferably from 60% to 90% by weight, particularly preferably from 70% to 80% by weight, based on the total weight of the respective polymer film (A3). It is particularly preferable when the at least one further polymer film (A3) consists of a TPE. It is very particularly preferable when the at least one polymer film (A3) consists of a TPU.

It is preferable when the at least one further polymer film (A3) has the same composition as the polymer film (A1) or (A2). It is very particularly preferable when all three polymer films (A1), (A2) and (A3) comprise a TPE to an extent of at least 50% by weight, preferably to an extent of at least 80% by weight, particularly preferably to an extent of 100% by weight, wherein the TPE is preferably one of the abovementioned TPEs, particularly preferably at least one TPU. It is particularly preferable when the further polymer film (A3) has the same composition as the first polymer film (A1).

In a preferred embodiment of the security document (A) the security feature (A4) is selected from the group consisting of a hologram, a print, a security thread, a fluorescent fibre, a dye, a security pigment, carbon black, metallic or non-metallic micro- or nanoparticles, magnetic particles, an embossing or a combination of at least two of these. It is preferable when the security feature (A4) is arranged in or on the second polymer layer (A2) or the least one further polymer layer (A3). It is preferable when the security feature (A4) is embedded in the security document (A) such that it is not accessible from outside the security document (A). It is preferable when the security feature (A4) is embedded in the security document (A) such that it is accessible only by destruction of the security document (A). The hologram may be any holographic structure known to those skilled in the art. It is preferable when the hologram is embossed into one of the polymer films (A1), (A2) or optionally (A3). However, the hologram may also be made up of small flakes which each comprise a hologram and have been admixed with the polymer films (A1), (A2) or optionally (A3) during their production. The print may be any kind of print known to those skilled in the art. It is preferable when the print in or on one of the polymer films (A1), (A2) or optionally (A3) is selected from relief printing, for example flexographic printing, planographic printing, for example offset printing, gravure printing and screen printing. The printing is preferably selected from the group consisting of screen printing, inkjet printing, pad printing, laser printing, pad printing, block printing, emboss printing, distortion printing and non-impact printing, such as direct thermal printing, thermal transfer printing, 3D printing, thermosublimation printing, laser marking or combinations of at least two of these.

The security feature (A4) is preferably in the form of an embossing. In a preferred embodiment of the security document (A) the security document (A) comprises at least one security feature (A4) in the form of an embossing (P) and also at least one further security feature (A4). The embossing (P) may take any form that a person skilled in the art would select for this purpose. It is preferable when the embossing (P) has a shape selected from the group consisting of a logo and a script, such as a name. The embossing (P) preferably has a shape which serves the individualization or personalization of the security document (A).

It is preferable when the depth of the embossing (P) is in a range from 50 to 500 μm, particularly preferably from 55 to 300 μm, very particularly preferably from 60 to 100 μm. To protect the embossing (P) from manipulation or destruction, the outer surface (AS1) or (AS2) into which the embossing (P) has been introduced is protected by a further layer.

The security thread can be any thread that a person skilled in the art would use for securing a document. It is preferable when the security thread is a thread which is preferably formed from polymers or natural raw materials such as cotton, wool, hemp or similar natural fibres and comprises UV fluorescent materials. The security thread preferably exhibits a structure or a colour that is easily detectable by the observer, especially under UV light, without obscuring other, especially informative, data comprised by the security document. It is preferable when the security document (A) comprises the security thread in an amount in a range from 0.1% to 10% by weight, more preferably in a range from 0.2% to 8% by weight, particularly preferably in a range from 0.5% to 5% by weight, based on the total weight of the security document (A).

The fluorescent fibre may be any fibre capable of being doped with a fluorescent dye. It is preferable when the fibre is a polymer fibre having a length in a range from 1 to 10 mm and a diameter in a range from 20 to 80 μm. It is preferable when the security document (A) comprises the fluorescent fibre in an amount in a range from 0.1% to 10% by weight, more preferably in a range from 0.2% to 8% by weight, particularly preferably in a range from 0.5% to 5% by weight, based on the total weight of the security document (A). Examples of such fibres are flecking fibres or planchettes. Flecking fibres are added to stamps for forgery resistance for example and are detectable as small, red luminescing fibres under a UV lamp. Planchettes are incorporated coloured discs, similar to flecking fibres. Planchettes may also be metallic or transparent; they can also fluoresce under UV light or be made of iridescent material that exhibits colour change. Special planchettes, such as for example for use in driver's licenses, react to manipulation attempts by bleeding a signal colour.

The dye, especially a dye fluorescent in UV light, may be any dye that a person skilled in the art would use to secure a document. The dye is preferably selected from the group consisting of allophycocyanine, berberine, brilliant sulfaflavin, quinine, coumarins, for example 4-methylumbelliferone, 1,3,2-dioxaborins (complexes of boric acid derivatives with 1,3-dicarbonyl compounds) fluoresceins (for example 5-octadecanoylaminofluorescein, 6-carboxy-4′,5′-dichloro-2′,7′-dimethoxyfluorescein-N-succinimidyl ester), fluorescent proteins (GFP, YFP, RFP), indocyanine green, sodium diuranate, nile blue/nile red, porphyrins (hemes, chlorophylls, etc.) quadrains (quadratic acid dyes) based on N,N-dialkylanilines, rhodamines, stilbenes, synthetic fluorescent labels and markers such as for example ATTO dyes (ATTO-TEC GmbH, Siegen), Alexa Fluor (Molecular Probes, Invitrogen Corp.) and cyanines (Cy3, Cy5, etc.) or a mixture of at least two of these.

It is preferable when the security document (A) comprises the dye in an amount in a range from 0.1% to 10% by weight, more preferably in a range from 0.2% to 8% by weight, particularly preferably in a range from 0.5% to 5% by weight, based on the total weight of the security document (A). Examples of suitable dyes are marking agents, IR or UV dyes, fluorescent dyes.

The security pigment may be any security pigment that a person skilled in the art would use for securing a document. In contrast to the pigment described merely for colouring one of the polymer films (A1), (A2) or (A3) the security pigment is a pigment which is added to the respective polymer layer (A1), (A2) or (A3) in a characteristic manner. Accordingly, the security pigment itself may have a particular property which is detected by means of a particular instrument, such as a scanner, or the security pigment may be added into the polymer film (A1), (A2) or (A3) thus. The security pigment is preferably selected from the group of rare earths consisting of gadolinium oxysulfide, yttrium oxysulfide, lanthanum oxysulfide, gadolinium oxide, samarium oxide, lutetium oxide, terbium oxide, yttrium oxide, lanthanum oxide, europium oxide, dysprosium oxide, praseodymium oxide, erbium oxide, holmium oxide, cerium oxide, neodymium oxide, ytterbium oxide, phosphorous-containing ferromagnetic pigment, in particular a pigment consisting substantially of iron and cobalt. It is preferable when the security document (A) comprises the pigment in an amount in a range from 0.1% to 10% by weight, more preferably in a range from 0.2% to 8% by weight, particularly preferably in a range from 0.5% to 5% by weight, based on the total weight of the security document (A).

It is preferable when the security document (A) comprises carbon black. It is preferable when the security document (A) comprises the carbon black in an amount in a range from 0.1% to 10% by weight, more preferably in a range from 0.2% to 8% by weight, particularly preferably in a range from 0.5% to 5% by weight, based on the total weight of the security document (A). If parts of the security document (A) are subsequently treated with a laser, identifiers such as numbers may be burned into the security document (A), for example, on account of the carbon black content without being capable of nondestructive alteration.

The metallic or non-metallic micro- or nanoparticles may be any kind of metallic or non-metallic micro- or nanoparticles that a person skilled in the art would use for securing a document. It is preferable when the metallic or non-metallic micro- or nanoparticles are selected from the group consisting of oxides or sulfides of rare earth metals, microholograms of the product line Charms from Viavi, microcrystals of the product line OVDots from Optaglio.

It is preferable when the security document (A) comprises the metallic or non-metallic micro- or nanoparticles in an amount in a range from 0.1% to 10% by weight, more preferably in a range from 0.2% to 8% by weight, particularly preferably in a range from 0.5% to 5% by weight, based on the total weight of the security document (A).

The magnetic particles may be any kind of magnetic particles that a person skilled in the art would use for securing a document. It is preferable when the magnetic particles are selected from the group consisting of oxides of gadolinium, terbium, yttrium, lanthanum, europium, dysprosium, praseodymium, erbium, holmium, neodymium, ytterbium. It is preferable when the security document (A) comprises the magnetic particles in an amount in a range from 0.1% to 10% by weight, more preferably in a range from 0.2% to 8% by weight, particularly preferably in a range from 0.5% to 5% by weight, based on the total weight of the security document (A).

In a preferred embodiment of the security document (A) at least one of the polymer films (A1), (A2) or optionally (A3), preferably the security document (A), has at least one of the following properties:
a. a tear propagation resistance in a range from 50 N/mm to 400 N/mm, more preferably from 60 N/mm to 350 N/mm, particularly preferably from 70 N/mm to 300 N/mm, determined according to DIN 53363:2003-10;
b. a tensile strength in a range from 20 MPa to 200 MPa, more preferably from 25 MPa to 170 MPa, particularly preferably from 30 MPa to 150 MPa, determined according to ISO 527-3:1995;
c. a light transmittance in a range from 0% to 85%, preferably from 1% to 50%, particularly preferably from 5% to 30%, determined according to ISO 13468-2:2019;
d. a content of security pigments in a range from 0.1% to 10% by weight based on the total weight of the security document (A);
e. a crease recovery angle in a range from 1200 to 170°, more preferably from 130° to 160°, particularly preferably from 140° to 150°, according to DIN 53 890/91;
f. a Vicat softening temperature of 30° C. to 180° C., particularly preferably of 40° C. to 175° C., particularly preferably of 50° C. to 170° C., according to DIN EN ISO 306
g. a nominal breaking elongation in a range from at least 60%, preferably from 60% to 800%, particular preferably from 100% to 500%, very particularly preferably from 130% to 250%, measured according to DIN EN ISO 527-1:2012.

It is preferable when the security document (A) has the properties or combinations of properties selected from the group consisting of a., b., c., d., e., f., g., a.+b., a.+c., a+d., a.+e., a.+f., a.+g., b.+c., b.+d., b.+e., b.+f., b.+g., c.+d., c.+e., c.+f., c.+g., d.+e., d.+f., d.+g., e.+g., f.+g., a.+b.+c., a.+b.+d., a.+b.+e., a.+b.+f., a.+b.+g., a.+c.+d., a.+c.+e., a.+c.+f., a.+c.+g., a.+d.+e., a.+d.+f., a.+d.+g., a.+e.+f., a.+e.+g., a.+f.+g., b.+c.+d., b.+c.+e., b.+c.+f., b.+c.+g., b.+d.+e., b.+d.+f., b.+d.+g., b.+e.+f., b.+e.+g., b.+f.+g., c.+d.+e., c.+d.+f., c.+d.+g., c.+e.+f., c.+e.+g., d.+e.+f., d.+e.+g., e.+f.+g., a.+b.+c.+d., a.+b.+c.+e., a.+b.+c.+f., a.+b.+c.+g., a.+b.+d.+e., a.+b.+d.+f., a.+b.+d.+g., a.+b.+e.+f., a.+b.+e.+g., a.+b.+f.+g., a.+c.+d.+e., a.+c.+d.+f., a.+c.+d.+g., a.+c.+e.+f., a.+c.+e.+g., a.+c.+f.+g., a.+d.+e.+f., a.+d.+e.+g., a.+d.+f.+g., a.+e.+f.+g., b.+c.+d.+e., b.+c.+d.+f., b.+c.+d.+g., b.+d.+e.+f., b.+d.+e.+g., b.+d.+f.+g., b.+e.+f.+g., c.+d.+e.+f., c.+d.+e.+g., c.+d.+f.+g., c.+e.+f.+g., d.+e.+f.+g., a.+b.+c.+d.+e., a.+b.+c.+d.+f., a.+b.+c.+d.+g., a.+b.+c.+e.+f., a.+b.+c.+e.+g., a.+b.+c.+f.+g., a.+b.+d.+e.+f., a.+b.+d.+e.+g., a.+b.+d.+f.+g., a.+b.+e.+f.+g.+g., a.+c.+d.+e.+f., a.+c.+d.+e.+g., a.+c.+d.+f.+g., a.+c.+e.+f.+g., a.+d.+e.+f.+g., b.+c.+d.+e.+f., b.+c.+d.+e.+g., b.+c.+d.+f.+g., b.+c.+e.+f.+g., c.+d.+e.+f., +g., a.+b.+c.+d.+e.+f. a.+b.+c.+d.+e.+g., a.+b.+c.+e.+f.+g., b.+c.+d.+e.+f+g., a.+b.+c.+d.+e.+f.+g. It is especially preferable when the security document (A) has the properties a. and g.

It is preferable when the polymer films (A1), (A2) or (A3) further comprise a UV stabilizer as an additive. It is preferable when the polymer films (A1), (A2) or (A3) comprise the UV stabilizer in an amount in a range from 0.1% to 15% by weight, more preferably in a range from 1% to 10% by weight, particularly preferably in a range from 2% to 7% by weight, based on the total weight of the respective polymer film (A1), (A2) or (A3).

A further aspect of the invention relates to a process for producing a security document (A) having a first outer surface (AS1) and a second outer surface (AS2) opposite the first outer surface (AS1) comprising the steps of:
i) providing a first polymer (A1′);
ii) providing a second polymer (A2′);
iii) optionally providing a further polymer (A3′);
iv) melting the polymers from step i), ii) and optionally iii);
v) either combining the polymer melts from step iv) to form a first polymer film (A1) from the first polymer (A1′), a second polymer film (A2) from the second polymer (A2′) and optionally a further polymer film (A3) from the first polymer (A1′) or from the further polymer (A3′) as a coextrudate or forming a laminate from in each case a separate polymer film (A1), (A2) and optionally (A3) formed from the melts in step iv);
vi) introducing a security feature (A4) selected from the group consisting of a hologram, a print, a security thread, a fluorescent fibre, a dye, a pigment, carbon black, metallic or non-metallic micro- or nanoparticles, magnetic particles, an embossing or a combination of at least two of these into or onto one of the polymer films (A1), (A2) or (A3) to obtain the security document (A);
vii) optionally joining, preferably ultrasonic welding, vibratory welding or laser welding, a polymer layer (A6) to one of the outer layers (AS1) or (AS2) over an area of at least 1 mm²,
   wherein the outer surfaces (AS1) and (AS2) are formed by one of the polymer films (A1), (A2) or (A3) which each comprise or consist of a TPE.

The providing of the first polymer (A1′) in step i), of the second polymer (A2′) in step ii) and/or optionally of the further polymer (A3′) in step iii) may be effected in any way known to those skilled in the art. It is preferable when the providing in step i), ii) and/or iii) is effected by introducing pellets of the respective polymer into an extruder or another instrument in which polymer may subsequently be melted.

Step iv) comprises melting the polymers from step i), ii) and optionally iii) preferably by heating the extruder with the extruder screw switched on. Step v) comprises combining the polymer melts from step iv). This is preferably done by means of a die suitable therefor. Alternatively, the melts from step iv) may also be successively applied to a substrate.

The melts in step v) are preferably co-extruded via a die in the form of extruded melts or formed as individual polymer films by casting. It is preferable when the melts are extruded in step v).

If the melts are each separately formed into the polymer films (A1), (A2) or (A3) they are preferably joined by lamination to afford the security document (A) in the form of a laminate. If the melts are extruded together using a die in step v) this forms the security document (A) in the form of an extruded film or coextruded film after cooling of the melts. The viscosity of the melts is preferably in a range suitable for polymer processing, in particular for flat film production, of between 20 and 2000 Pa s, preferably in the range from 50 to 1000 Pa s, particularly preferably in the range from 75 to 500 Pa s. It is immaterial whether the polymer melt is a polymer with a defined melting point Tm or a defined melting interval Tm±ΔT or whether it is a polymer without a defined melting point. It is preferable when in the extrusion, in particular at the point of exiting the die, the polymer has been heated sufficiently above the melting point Tm or the glass transition point Tg that the viscosity of the polymer is reduced sufficiently to allow processing to afford a polymer film.

During the extrusion of the melts in step v) it is preferable to introduce at least one further film between the individual melts as security feature (A4) in step vi). The at least one supplied film preferably has a thickness in a range from 5 to 35 μm, more preferably from 7 to 25 μm, particularly preferably from 10 to 20 μm. This at least one further film may be introduced over the entire width of the melts in step v) or else only over a section of the melts. It is preferable when the at least one further film has a width which corresponds to 30% to 100%, more preferably 40% to 90%, particularly preferably 50% to 80%, of the width of the melt. The at least one further film is preferably used to introduce the security feature (A4).

After the extrusion of the polymer melts of the polymers (A1′), (A2′) and optionally (A3′) through the die to a film, the extruded film is preferably guided onto two rolls. It is preferable when one or both rolls have a ductile surface. This allows a more homogeneous pressure distribution over the total width of the extrudate. This may especially be advantageous when the thin film supplied in the roll nip which serves as security feature (A4) has recesses or printed symbols in a colour layer thickness up to 20 μm in whose region, due to a deficit or excess of material, the pressure over the rolls may vary. Ductile rolls can compensate for this pressure difference, thus resulting in improved adhesion even in these regions. Such rolls are, for example, PTFE-coated or PTFE-sheathed rubber rolls or silicone-coated rolls.

Step vi) preferably comprises introducing a first security feature (A4) in the form of an embossing (P) into the formed security document (A) by embossing. The embossing is preferably carried out by means of a metal embossing punch, for example in the form of a cylinder or a flat metal sheet. The embossing stamp is pressed onto one side of the multilayer film with a pressure of 40N/cm² to 800N/cm² at a temperature in a range from 15° C. to 80° C. so that the embossing (P) is visible and feelable on the outer surface (AS1) or (AS2) of the security document (A) in one of the polymer films (A1) or (A3).

As mentioned above, security features (A4) or combinations of security features (A4) may be incorporated in the resulting security document (A). Examples preferably include: flecking fibres, planchettes, metal fibres, marking agents, IR or UV dyes, security pigments, fluorescent dyes, effect pigments or security threads, wherein these security features (A4) are added as an additive to the pellet-form polymer mixture in step i) or to the melt in step iv), or in step v) are introduced by scattering in the vicinity of the roll nip or blown onto the melt tail or in the case of a security thread or a security film guided into the roll nip. It is likewise possible to provide a security feature (A4) in the thin supplied film. This allows the security features already known from the field of paper banknotes to be used without further modification as described in DE 6 98 33 653 T2, in particular in claim 1, or in CH 704 788 A1 on page 7. Security features known from paper documents include: security threads, OVD, flecking fibres, security pigments, iridescent colour applications, chips, especially RFID chips, magnetic strips.

It is alternatively preferable to employ a gravure roll as one of the rolls.

Extrusion is preferably carried out on the basis of a simple melt of a reacted polymer. It may alternatively be preferable to employ a prepolymer, as described in CH 704 788 A1, as a starting material to form one of the polymer films (A1), (A2) or optionally (A3). The prepolymer is preferably supplied to a further melt of a polymer which forms one of the other polymer films (A1), (A2) or optionally (A3) before or after the roll nip. The prepolymer is subsequently subjected to chemical or physical curing and/or reaction and/or gelling. The present invention further relates to a multilayer substrate, as may be produced in an above-described process, or as is in fact produced by a process as described above.

It is preferable when a linear pressure in a range from 0 to 500 N/cm, more preferably from 250 to 450 N/cm, is applied between the roll pair immediately after introduction of the melt. The roll pair is preferably kept at a temperature above room temperature, preferably in a range from 50° C. to 180° C., more preferably from 60° C. to 120° C., particularly preferably from 70° C. to 100° C. The roll temperature ideally should not be above the melting temperature or above the glass transition point of the employed materials of the resulting polymer films (A1), (A2) or optionally (A3). It is preferable to employ a temperature of the rolls just below the glass transition point Tg and/or the melting point Tm of the lowest melting point polymer. If the melt in step v) is composed of reacted polymers then the roll temperatures may also be just above the melting temperature or above the glass transition point.

The introducing of the security feature (A4) in step vi) may be effected in any manner known to those skilled in the art. It is preferable when the introducing of the security feature (A4) in step vi) is effected via a measure selected from the group consisting of mixing a security thread, a fluorescent fibre, a dye, a pigment, carbon black, metallic or nonmetallic micro- or nanoparticles, magnetic particles, an embossing or a combination of at least two of these with the respective polymer (A1′), (A2′) or (A3′), preferably with the melt thereof in step iv), introducing a hologram into the coextruded film or the laminate from step v) or printing the coextruded film or the laminate from step v) by a process known to those skilled in the art for printing such coextruded films or laminates. The printing in step vi) may preferably be effected by a process selected from the group consisting of ink jet printing, screen printing, laser jet printing, laser gravure or a combination of at least two of these.

Alternatively or in addition the introducing of the security feature (A4) may be effected in the form of an embossing on one of the polymer layers (A1), (A2) or (A3).

Fibres (A5) may optionally be introduced into, between or onto the melts. These may also be applied to the formed multilayer film as a distinct ply or joined thereto. It is preferable when the fibres (A5) have been introduced into the melt of the polymers (A1′) or (A3′).

The optional joining of the further polymer layer (A6) onto one of the outer layers (AS1) or (AS2) in step vii) over an area of at least 1 mm² may be effected by any joining method known to those skilled in the art for the joining of polymer films. The joining is preferably selected from ultrasonic welding, vibratory welding, laser welding or a combination of at least two of these. The polymer layer (A6) is for example the data page of a passport.

The configuration of the polymer films (A1), (A2) and optionally (A3) corresponds to the polymer films as specified in connection with the security document (A) according to the invention. Especially the composition, thickness, length and width and also the shape and properties are the same as described previously for the polymer films (A1), (A2) and optionally (A3).

It is preferable when all polymer films (A1), (A2) and (A3) consist exclusively of polymers. It is preferable when the complete security document (A) with the exception of the security feature (A4) and optionally the fibres (A5) consists of polymers.

One advantage of the process according to the invention for producing a security document (A) is the high flexibility in terms of varying the polymers to be processed. Changes in material are possible in the shortest possible timeframes, thus also facilitating the production of smaller batch sizes. In addition the polymer pellets may be easily admixed before extrusion with marking agents in the form of a security feature (A4) such as dyes, security pigments, fluorescent dyes, effect pigments, interference pigments, metal pigments, reactive dyes but also with further additives such as UV absorbers, stabilizers and further additives, in particular those already described in connection with the security document (A) according to the invention, preferably in the form of a masterbatch which allows simple individualization, protection from environmental influences and further securing of the security document (A). The selection and amount of the different security features (A4) are apparent from the foregoing in respect of the security document (A) according to the invention and likewise apply to the process according to the invention.

Similarly to the security document (A) according to the invention, preferred materials therefor are in particular plastics from the group of thermoplastic elastomers, for example thermoplastic polyurethanes, copolyesters, polyether block amides, thermoplastic polyolefins, styrene block copolymers and mixtures of at least two of the recited polymers. On account of their chemical structure these exhibit particularly good compatibility in extrusion, coextrusion and the production of blends. After combining during the extrusion, lamination or coating they therefore exhibit a particularly intimate bond which is based firstly on good cohesion and secondly on good compatibility of the individual components. Further advantageous properties of a polymeric material for a security document (A) according to the invention are high chemical resistance towards acids, bases, solvents, bleaches etc., high thermal stability and UV stability, high opacity, high bending fatigue strength and high softening temperatures.

Film laminates produced by extrusion lamination are typically formed such that the thin film to be laminated, for example film (A1) made of polymer (A1′) is run on a roughened, heated or cooled metal roll and the melt of the second polymer, for example (A2′), from the slot die is pressed against the first metal roll by a rubber-sheathed roughened roll, thus pressing the polymer melt onto the supplied film. The textures of the roughened surfaces of the rolls are transferred to the molten polymer as well as to the supplied film to be laminated. A cooling of the temperature-controlled roll pair to below the solidification temperature of the polymer prevents adhesion of the film to the rubber roll. Since the polymer (A1′), (A2′) or optionally (A3′) comes into contact with the supplied thin film (A1), (A2) or optionally (A3) directly in molten form the influence of heat on the supplied film is only of short duration and thus hardly detrimental. The provided polymer film, for example polymer film (A1), preferably comprises a TPU onto which the melt of a PC is applied. It is possible to operate with relatively high melt temperatures in the range from 200° C. to 250° C. This has the advantage that the high temperature of the melt makes it possible to achieve a lower melt viscosity, thus leading to a better and faster joining of the plastics layers and allowing a more intimate bond as required for a security document (A). This simultaneously allows faster process speeds.

It is preferable when the roll pair comprises temperature-controllable rolls having a matte surface which is transferred to the extruded layer composite to a certain extent during the extrusion. It is also possible to employ two metal rolls as an alternative to a roll pair composed of one rubber roll and one metal roll. Matte surfaces are especially to be understood as meaning those having a roughness in a range from 10 to 30 μm.

If two metal rolls are used it is preferable for one of the two metal rolls to be thin-walled and under hydraulic pressure from the inside. This causes the metal roll to function like a rubber roll since in the case of thickenings, such as printing with thick colour layers etc., it can undergo local deformation.

Metal rolls with surfaces polished to a high shine produce films with correspondingly smooth surfaces. These films are not suitable for security printing because they stick together and are printable at high speeds only with great difficulty. These films are typically separated with ionized compressed air before being supplied to the printing machine. An alternative to polished rolls are rolls which have only locally polished areas which can later be found for example in certain places on the security document (A), such as banknotes.

In the production of the security document (A) by coextrusion of at least three polymer films (A1), (A2) and (A3) in a symmetrical structure, for example with an inner polymer film (A2) of a polymer (A2′) and respective outer polymer films (A1) and (A3) of polymers (A1′) and (A3′), wherein polymers (A1′) and (A3′) are particularly preferably identical, the softening temperature of the outer polymer (A1′) or (A3′) is preferably below that of the inner polymer (A2′). Alternatively the outer polymer (A1′) or (A3′) has a lower melt viscosity than the inner polymer (A2′) under the given processing conditions. This makes it possible through suitable selection of the outer polymer to optimize the printability of the resulting security document (A). For the inner polymer film (A2) it is preferable to select a polymer (A2′) for optimized mechanical properties of the film. Such a multilayer polymer ply is preferably made up of largely compatible, i.e. easily coextrudable, polymers such as thermoplastic polyurethanes (TPU), copolyesters, polyether block amides, thermoplastic polyolefins, styrene block copolymers and mixtures of at least two of these.

It is preferable when additional material is incorporated between the polymer films (A1) or (A3) and (A2) during the production process of the security document (A). It is preferable to feed a security thread into the roll nip as security feature (A4) which is thus securely co-incorporated between the individual plies. The thread is ideally provided with an adhesive, as is not unusual for security threads, and is thus bonded to one of the outer polymer films (A1) or (A3) via the temperature-controlled roll.

In a preferred embodiment of the process at least one of the polymers selected from the group consisting of the polymer (A1′), the polymer (A2′), optionally the polymer (A3′) is a polymer selected from the group consisting of a thermoplastic polyamide elastomer, an olefin-based thermoplastic elastomer, preferably PP/EPDM, a thermoplastic styrene block copolymer (SBS, SEBS, SEPS, SEEPS and MBS), a thermoplastic polyurethane (TPU), a copolyester elastomer, a polyether block amide, a copolyester, a polycarbonate, a polyethylene terephthalate (PET), a polyethylene terephthalate glycol (PETG) or a mixture of at least two of these, preferably TPU. Examples of these materials have already been described in the description of the security document (A) according to the invention and likewise apply to the materials employed in the process according to the invention.

It is preferable when the second polymer film (A2) comprises a polymer selected from the group consisting of a TPE, a copolyester, a polyether block amide or a mixture of at least two of these in an amount in a range from 50% to 100% by weight, preferably from 60% to 90% by weight, particularly preferably from 70% to 80% by weight, based on the total weight of the polymer film (A2).

It is preferable when the first polymer film (A1) comprises the TPE in an amount in a range from 50% to 100% by weight, preferably from 60% to 90% by weight, particularly preferably from 70% to 80% by weight, based on the total weight of the polymer film (A1).

Moreover, at least one of the polymers (A1′), (A2′) or (A3′) comprises further additives for various purposes, such as UV protection, easier processing, colouring etc. Examples of customary additives especially include those as described in connection with the security document (A) according to the invention or:
1. Antioxidants
1.1 Alkylated monophenols, for example 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-i-butylphenol, 2,6-di-cyclopentyl-4-methylphenol, 2-(α-methylcyclohexyl)-4,6-dimethylphenol, 2,6-di-octadecyl-4-methylphenol, 2,4,6-tricyclohexylphenol, 2,6-di-tert-butyl-4-methoxymethylphenol.
1.2 Alkylated hydroquinones, for example 2,6-di-tert-butyl-4-methoxyphenol, 2,5-di-tert-butyl-hydroquinone, 2,5-di-tert-amyl-hydroquinone, 2,6-diphenyl-4-octadecyloxyphenyl.
1.3 Hydroxylated thiodiphenyl ethers, for example 2,2′-thio-bis-(6-tert-butyl-4-methylphenol), 2,2′-thio-bis-(4-octylphenol), 4,4′-thio-bis-(6-tert-butyl-3-methylphenol), 4,4′-thio-bis-(6-tert-butyl-2-methylphenol).
1.4 Alkylidene bisphenols, for example 2,2′-methylene-bis-(6-tert-butyl-4-methylphenol), 2,2′-methylene-bis-(6-tert-butyl-4-ethylphenol), 2,2′-methylene-bis-(4-methyl-6(α-methylcyclohexyl)-phenol), 2,2′-methylene-bis-(4-methyl-6-cyclohexylphenol), 2,2′-methylene-bis-(6-nonyl-4-methylphenol), 2,2′-methylene-bis-(4,6-di-tert-butylphenol), 2,2′-ethylidene-bis-(4,6-di-tert-butylphenol), 2,2′-ethylidene-bis-(6-tert-butyl-4-isobutylphenol), 2,2′-methylene-bis-[6-(α-methylbenzyl)-4-nonylphenol], 2,2′-methylene-bis-[6-(α,α-dimethylbenzyl)-4-nonylphenol], 4,4′-methylene-bis-(2,6-di-tert-butylphenol), 4,4′-methylene-bis-(6-tert-butyl-2-methylphenol), 1,1-bis-(5-tert-butyl-4-hydroxy-2-methylphenyl)-butane, 2,6-di-(3-tert-butyl-5-methyl-2-hydroxybenzyl)-4-methylphenol, 1,1,3-tris-(5-tert-butyl-4-hydroxy-2-methylphenyl)butane, 1,1-bis-(5-tert-butyl-4-hydroxy-2-methylphenyl)-3-n-dodecylmercaptobutane, ethylene-glycol-bis[3,3-bis-(3′-tert.butyl-4′-hydroxyphenyl)-butyrate], di-(3-tert-butyl-4-hydroxy-5-methyl-phenyl)-dicyclopentadiene, di-[2-(3′-tert-butyl-2′-hydroxy-5′-methylbenzyl)-6-tert-butyl-4-methyl-phenyl]-terephthalate.
1.5 Benzyl compounds, for example 1,3,5-tri-(3,5-di-tert-butyl-4-hydroxybenzyl)-2,4,6-trimethylbenzene, di-(3,5-di-tert-butyl-4-hydroxybenzyl)-sulfide, isooctyl 3,5-di-tert-butyl-4-hydroxybenzyl-mercaptoacetate, bis-(4-tert-butyl-3-hydroxy-2,6-dimethylbenzyl)-dithiol terephthalate, 1,3,5-tris-(3,5-di-tert-butyl-4-hydroxybenzyl) isocyanurate, 1,3,5-tris-(4-tert-butyl-3-hydroxy-2,6-dimethylbenzyl) isocyanurate, dioctadecyl 3,5-di-tert-butyl-4-hydroxybenzyl-phosphonate, the calcium salt of the monoethyl ester of 3,5-di-tert-butyl-4-hydroxybenzylphosphonic acid.
1.6 Acylaminophenols, for example 4-hydroxylaurylanilide, 4-hydroxystearylanilide, 2,4-bis-octylmercapto-6-(3,5-di-tert-butyl-4-hydroxyanilino)-s-triazine, octyl N-(3,5-di-tert-butyl-4-hydroxy-phenyl)-carbamate.
1.7 Esters of β-(3,5-di-tert-butyl-4-hydroxyphenyl)-propionic acid with monohydric or polyhydric alcohols, for example methanol, octadecanol, hexane-1,6-diol, neopentyl glycol, thiodiethylene glycol, diethylene glycol, triethylene glycol, pentaerythritol, tris-hydroxyethyl isocyanurate, di-hydroxyethyloxalamide.
1.8 Esters of β-(5-tert-butyl-4-hydroxy-3-methylphenyl)-propionic acid with monohydric or polyhydric alcohols, for example with methanol, octadecanol, hexane-1,6-diol, neopentyl glycol, thiodiethylene glycol, diethylene glycol, triethylene glycol, pentaerythritol, trishydroxyethyl isocyanurate, dihydroxyethyloxalamide.
1.9 Amides of β-(3,5-di-tert-butyl-4-hydroxyphenyl)-propionic acid, for example N,N′-di-(3,5-di-tert-butyl-4-hydroxyphenylpropionyl)-hexamethylenediamine, N,N′-(3,5-di-tert-butyl-4-hydroxyphenyl-propionyl)-trimethylenediamine, N,N′-di-(3,5-di-tert-butyl-4-hydroxyphenylpropionyl)-hydrazine.
2. UV absorbers and light stabilizers
2.1 2-(2′-hydroxyphenyl)-benzotriazoles, for example the 5′-methyl, 3′,5′-di-tert-butyl, 5′-tert-butyl, 5′-(1,1,3,3-tetramethylbutyl), 5-chloro-3′,5′-di-tert-butyl, 5-chloro-3′-tert-butyl-5′-methyl, 3′-sec-butyl-5′-tert-butyl, 4′-octoxy, 3′,5′-di-tert-amyl and 3′,5′-bis-(α,α-dimethylbenzyl) derivative.
2.2 2-hydroxybenzophenones, for example the 4-hydroxy, 4-methoxy, 4-octoxy, 4-decyloxy, 4-dodecyloxy, 4-benzyloxy, 4,2′,4′-trihydoxy and 2′-hydroxy-4,4′-dimethoxy derivative.
2.3 Esters of optionally substituted benzoic acids, for example 4-tert-butylphenyl salicylate, phenyl salicylate, octylphenyl salicylate, dibenzoylresorcinol, bis(4-tert-butylbenzoyl)-resorcinol, benzoyl resorcinol, 2,4-di-tert-butylphenyl 3,5-di-tert-butyl-4-hydroxybenzoate, hexadecyl 3,5-di-tert-butyl-4-hydroxybenzoate.
2.4 Acrylates, for example ethyl α-cyano-β,β-diphenylacrylate or isooctyl α-cyano-β,β-diphenylacrylate, methyl α-carbomethoxycinnamate, methyl α-cyano-β-methyl-p-methoxycinnamate or butyl α-cyano-β-methyl-p-methoxycinnamate, methyl α-carbomethoxy-p-methoxy-cinnamate, N-(β-carbomethoxy-β-cyanovinyl)-2-methyl-indoline.
2.5 Nickel compounds, for example nickel complexes of 2,2′-thio-bis-[4-(1,1,3,3-tetramethylbutyl)-phenol], such as the 1:1 or 1:2 complex, optionally with additional ligands, such as n-butylamine, triethanolamine or N-cyclohexyl-diethanolamine, nickel dibutyldithiocarbamate, nickel salts of monoalkyl 4-hydroxy-3,5-di-tert-butylbenzyl-phosphonate, such as of methyl or ethyl 4-hydroxy-3,5-di-tert-butylbenzyl-phosphonate, nickel complexes of ketoximes, such as of 2-hydroxy-4-methyl-phenyl-undecylketonoxime, nickel complexes of 1-phenyl-4-lauroyl-5-hydroxypyrazole, optionally with additional ligands.
2.6 Sterically hindered amines, for example bis-(2,2,6,6-tetramethylpiperidyl) sebacate, bis-(1,2,2,6,6-pentamethylpiperidyl) sebacate, n-butyl-3,5-di-tert-butyl-4-hydroxybenzyl-malonic acid bis-(1,2,2,6,6-pentamethylpiperidyl) ester, the condensation product of 1-hydroxyethyl-2,2,6,6-tetramethyl-4-hydroxypiperidine and succinic acid, the condensation product of N,N′-(2,2,6,6-tetramethyl-4-piperidyl)-hexamethylenediamine and 4-tert-octylamino-2,6-dichloro-1,3,5-s-triazine, tris-(2,2,6,6-tetramethyl-4-piperidyl) nitrotriacetate, tetrakis-(2,2,6,6-tetramethyl-4-piperidyl)-1,2,3,4-butanetetracarboxylic acid, 1,1′-(1,2-ethanediyl)-bis-(3,3,5,5-tetramethylpiperazinone).
2.7 Oxalamides, for example 4,4′-di-octyloxy-oxanilide, 2,2′-di-octyloxy-5,5′-di-tert-butyl-oxanilide, 2,2′-di-dodecyloxy-5,5′-di-tert-butyl-oxanilide, 2-ethoxy-2′-ethyl-oxanilide, N,N′-bis-(3-dimethyl-aminopropyl)-oxalamide, 2-ethoxy-5-tert-butyl-2′-ethyloxanilide and a mixture thereof with 2-ethoxy-2′-ethyl-5,4′-di-tert-butyl-oxanilide, mixtures of o- and p-methoxy- and o- and p-ethoxy-disubstituted oxanilides.
3. Metal deactivators, for example N,N′-diphenyloxalamide, N-salicylal-N′-salicyloylhydrazine, N,N′-bis-salicyloylhydrazine, N,N′-bis-(3,5-di-tert-butyl-4-hydroxyphenylpropionyl)hydrazine, 3-salicyloylamino-1,2,4-triazole, bis-benzylidene-oxalyldihydrazide.
4. Phosphites and phosphonites, for example triphenyl phosphite, diphenylalkyl phosphites, phenyldialkyl phosphites, tri-(nonylphenyl) phosphite, trilauryl phosphite, trioctadecyl phosphite, distearyl pentaerythritol diphosphite, tris-(2,4-di-tert-butylphenyl) phosphite, diisodecylpentaerythritol diphosphite, di-(2,4-di-tert-butylphenyl)pentaerythritol diphosphite, tristearyl sorbitol triphosphite, tetrakis-(2,4-di-tert-butylphenyl)-4,4′-biphenylene diphosphonite, 3,9-bis-(2,4-di-tert-butylphenoxy-2,4,8,10-tetraoxa-3,9-diphosphaspiro[5,5]undecane.
5. Peroxide-destroying compounds, for example esters of β-thiodipropionic acid, for example the lauryl, stearyl, myristyl or tridecyl esters, mercaptobenzimidazole, the zinc salt of 2-mercaptobenzimidazole, zinc dibutyl dithiocarbamate, dioctadecyl disulfide, pentaerythritol tetrakis-(β-dodecylmercapto)-propionate.
6. Polyamide stabilizers, for example copper salts in combination with iodides and/or phosphorus compounds and salts of divalent manganese.
7. Basic co-stabilizers, for example melamine, polyvinylpyrrolidone, dicyandiamide, triallyl cyanurate, urea derivatives, amines, polyamides, polyurethanes, alkali and alkaline earth metal salts of higher fatty acids, for example Ca stearate, Zn stearate, Mg stearate, Na ricinoleate, K palmitate, antimony catecholate or tin catecholate.
8. Nucleating agents, for example 4-tert-butylbenzoic acid, adipic acid, diphenylacetic acid.
9. Fillers and reinforcers, for example calcium carbonate, silicates, glass fibres, asbestos, talc, kaolin, mica, barium sulfate, metal oxides and hydroxides, carbon black, graphite.
10. Other additives, for example plasticizers, lubricants, emulsifiers, pigments, optical brighteners, flame retardants, antistats, blowing agents.

The polymers (A1′), (A2′) and/or (A3′) are obtained by mixing the correspondingly selected aforementioned additives with the starting materials for the polymers (A1′), (A2′) and/or (A3′). It is preferable when the polymers (A1′), (A2′) and/or (A3′) comprise one or more of the aforementioned additives in each case in an amount in a range from 0.01% to 10% by weight, more preferably from 0.05% to 5% by weight, particularly preferably from 0.1% to 3% by weight, based on the total weight of the respective polymer (A1′), (A2′) and/or (A3′). Mixing may be effected in any manner by known techniques, for example via kneaders or screw extruders. Further processing is effected by the known techniques of thermoplastics processing, for example by extrusion or injection moulding.

In a preferred embodiment of the process a further layer is applied to at least one surface (AS1) or (AS2) of the security document (A), wherein the further layer is preferably a paper, a fibre composite, a textile or a combination of at least two of these. This makes it possible to provide a security document (A) which is used as an “end page” in passports for example. The end page refers to the outermost page stitched together with further films which is bonded to the passport cover.

A further aspect of the invention relates to a use of the security document (A) according to the invention or produced according to the process according to the invention as a banknote, birth certificate, stamp, tax stamp, visa pages of a passport, hinge for the data page of a passport, carrier layer of an electromagnetic shielding in a passport. It is preferable when the security document (A) is used for production as a banknote or the visa page of a passport.

### EXAMPLES

Production of a Masterbatch with 30% TiO₂.

Masterbatch: Compounding a highly concentrated TiO₂ masterbatch

Production of the masterbatches for the production of the polymer films (A1) or (A3) was carried out with a conventional twin-screw compounding extruder (ZSK 32) at processing temperatures customary for TPU of 190° C. to 250° C.
a) A masterbatch a) having the following composition was compounded and pelletized:
   70% by weight of Desmopan™ 9365D from Covestro Deutschland AG, Germany
   30% by weight of Kronos 2260 TiO₂ from Kronos Titan GmbH, Germany.
b) A masterbatch b) having the following composition was compounded and pelletized:
   70% by weight of Desmopan™ 9385D from Covestro Deutschland AG (Germany)
   30% by weight of Kronos® 2260 TiO₂ from Kronos Titan GmbH, Germany
c) A masterbatch c) having the following composition was compounded and pelletized:
   14% by weight of Desmopan™ 9365D from Covestro Deutschland AG (Germany)
   56% by weight of Tritan® MX710 from EASTMAN Chemical GmbH (Germany)
   30% by weight of Kronos 2260 TiO₂ from Kronos Titan GmbH, Germany

### The Apparatus Used for Production of the Extruded or Coextruded Film Comprised:

An extruder a) for single-layer films made of (A1′) or two extruders a) and b) for co-extrusion of polymers (A1′) and (A2′), the extruders containing at least one screw of 60 mm diameter (D) and a length of 33 D and the screws having a degassing zone;
a melt pump;
a crosshead;
a multilayer block;
a slot die of 450 mm in width;
a three-roll smoothing calender with horizontal roll arrangement, wherein the third roll is pivotable by +/−450 relative to the horizontal;
a roll conveyor;
a thickness measuring means;
a means for double-sided application of protective film;
a haul-off;
a winding station.

### Example 1) Production of a Single-Layer TPU Film, Thickness 80 μm, Non-Inventive (n.i.)

The pellets of masterbatch a) from example 1) were conveyed from the dryer into the fill hopper of the extruder a).

In addition, pellets of the plastic Desmopan™ 9365D from Covestro Deutschland AG were conveyed into the fill hopper of the extruder a).

The following weight ratio of masterbatch a) to Desmopan™ 9365D in the fill hopper was established:
50% by weight of masterbatch a) white;
50% by weight of Desmopan™ 9365D.

In the plasticizing system, i.e. the barrel and the screw of the extruder, the mixture of masterbatch a) and Desmopan™ 9365D was melted at processing temperatures customary for TPUs of 190° C. to 250° C., in particular 210° C. to 240° C., and pressures of 10 to 1500 bar, preferably 500 bar. The resulting melt conveyed from the screw to the slot die then passes on to the smoothing calender. The final shaping and cooling of the film was effected on the smoothing calender (consisting of three rolls). A matted steel roll and a matted silicone-rubber roll were used for embossing of the surfaces. The rubber roll used for texturing the film surface is disclosed in U.S. Pat. No. 4,368,240 of Nauta Roll Corporation. The film was subsequently transported through a haul-off and then the film was wound up on a roll.

### Example 2) Production of an Inventive White TPU Film, Thickness 80 μm

### Production of the Extruded Film

The pellets of masterbatch a) from example 1) were conveyed from the dryer into the fill hopper a) of the extruder a). In addition, pellets of the plastic Desmopan™ 9365D from Covestro Deutschland AG were conveyed into the fill hopper a) of the extruder a).

The pellets of masterbatch b) from example 1) were conveyed from the dryer into the fill hopper b) of the extruder b).

The following weight ratio of masterbatch a) to Desmopan™ 9365D in the fill hopper a) was established:
50% by weight of masterbatch a) white
50% by weight of Desmopan™ 9365D.

Also conveyed into the fill hopper b) of the extruder b) were pellets of the plastic Desmopan™ 9385D from Covestro Deutschland AG.

The following weight ratio of masterbatch b) to Desmopan™ 9385D in the fill hopper b) was established:
50% by weight of masterbatch b) white;
50% by weight of Desmopan™ 9385D

In the barrel/screw plasticizing system of the extruder the materials were melted and conveyed at processing temperatures customary for most TPEs, in particular TPUs, of 190° C. to 250° C., in particular 210° C. to 240° C., and pressures of 10 to 1500 bar, preferably 500 bar. Materials from extruder a) and extruder b) were combined in the slot die in the form of a multilayer block to form a trilayer structure of the extruded film. The material from extruder a) formed the two outer layers (first polymer film (A1) and further polymer film (A3)) in a thickness of 15 μm in each case and the melt from the extruder b) formed the middle layer in the form of the second polymer film (A2) in a thickness of 50 μm. To this end, the melts from extruders a) and b) passed via the slot die on to the smoothing calender. The final shaping and cooling of the film was effected on the smoothing calender (consisting of three rolls). A matted steel roll and a matted silicone-rubber roll were used for embossing of the surfaces. The rubber roll used for texturing the film surface is disclosed in U.S. Pat. No. 4,368,240 of Nauta Roll Corporation. The film was subsequently transported through a haul-off and then the film was wound up on a roll.

### Example 3): Production of an Inventive White TPU Film, Thickness 80 μm, Comprising a Core Layer of TPU Copolyester Blend and TPU Outer Layers

The pellets were filled into the extruder as in example 2, in the following quantity ratios: The following weight ratio of masterbatch a) to Desmopan™ 9365D in the fill hopper a) was established:
50% by weight of masterbatch a) white
50% by weight of Desmopan™ 9365D.

In addition, the following pellet mixture c) was conveyed into the fill hopper b) of the extruder b):
20% by weight of Desmopan™ 9365D.
80% by weight of Tritan© MX710.

The following weight ratio of masterbatch c) to mixture c) in fill hopper b) was established:
50% by weight of masterbatch c) white
50% by weight of pellet mixture c)

Subsequently, the melt of the polymer mixture was produced and processed into the security document in the extruders as described in example 2.

### Example 4) Production of an Inventive Colourless TPU Film, Thickness 80 μm from TPU

### Production of the Extruded Film:

The Desmopan™ 9365D pellets were conveyed from the dryer into the fill hopper a) of the extruder a). Desmopan™ 9385D pellets were conveyed into the fill hopper b) of the extruder b).

Subsequently, the melt of the polymer mixture was produced and processed into the security document in the extruders as described in example 2.

### Example 5): Production of an Inventive Colourless TPU Film, Thickness 80 μm, Comprising a Core Layer of TPU Copolyester Blend

### Production of the Extruded Film:

The Desmopan™ 9365D pellets were conveyed from the dryer into the fill hopper a) of the extruder a) as polymer (A1′). The following pellet mixture b) was conveyed into the fill hopper b) of the extruder b) as polymer (A2′):
20% by weight of Desmopan™ 9365D
80% by weight of Tritan® MX710

Subsequently, the melt of the polymer mixture was produced and processed into the security document in the extruders as described in example 2.

### Example 6): Production of Multilayer Colourless TPU Film in a Thickness of 80 μm Comprising a Core Layer of Copolyester

### Production of the Extruded Film:

The Desmopan™ 9365D pellets were conveyed from the dryer into the fill hopper a) of the extruder a). The Tritan™ MX710 pellets were conveyed from the dryer into the fill hopper b) of the extruder b). Subsequently, the melt of the polymer mixture was produced and processed into the security document in the extruders as described in example 2.

### Example 7): Production of Multilayer White TPU Film in a Thickness of 80 μm Comprising a Core Layer of Copolyester and Comprising UV Stabilizer and Antistat in the Outer Layers of the Extruded Film

### Production of the Extruded Film:

The pellets of the masterbatch a) were conveyed from the dryer into the fill hopper a). The following materials were additionally admixed with the material in fill hopper a):
2% by weight of the UV stabilizer Tinuvin® P from BASF AG (Germany).
10% by weight of the antistat Irgastat® P 18 from BASF AG (Germany).

The mixture in the fill hopper a) was conveyed into the extruder a).

The material Tritan® MX710 and the masterbatch b) were filled into the fill hopper b) of the extruder b). The following mixing ratio was established:
50% by weight of Tritan® MX710
50% by weight of masterbatch b)

The mixture in the fill hopper b) was conveyed into the extruder b).

Subsequently, the melt of the polymer mixture was produced and processed into the security document in the extruders as described in example 2.

### Example 8): Production of Multilayer White TPU Film in a Thickness of 80 μm Comprising a Core Layer of Copolyester and Comprising a UV-Fluorescent Security Feature (A4) in the Outer Layers of the Extrusion Film

### Production of the Extruded Film:

The following materials were conveyed into the fill hopper a) of the extruder a), wherein the masterbatch a) from example 1) and the Desmopan™ 9365D were conveyed from the dryer:
45% by weight of masterbatch a) white
45% by weight of Desmopan™ 9365D from Covestro Deutschland AG (Germany)
5% by weight of Lumogen® UV 560 from BASF AG (Germany) as security feature (A4)

The mixture in the fill hopper a) was conveyed into the extruder a).

The material Tritan® MX710 and the masterbatch d) from example 1) were filled into the fill hopper b) of the extruder b). The following mixing ratio was established:
50% by weight of Tritan® MX710
50% by weight of masterbatch b)

The mixture in the fill hopper b) was conveyed into the extruder b).

Subsequently, the melt of the polymer mixture was produced and processed into the security document in the extruders as described in example 2.

### Example 9): Production of a Multilayer Film by Extrusion Lamination

In a temperature-controlled metal-rubber roll pair having a matt texture on both roll sides, two TPU films made of Desmopan™ 9365D from Covestro Deutschland AG were supplied to the roll nip as polymer film (A1) and (A3) in a thickness of 30 μm. Each of the polymer films (A1) and (A3) comprised areas of inward-oriented security features (A4) in the form of hologram strips which were applied in the form of a 20 μm-thick polyester film. A melt tail of Desmopan™ 9385D from Covestro Deutschland AG was introduced between the roll pair onto the sides of the polymer films (A1) and (A3) comprising the security feature (A4) through a slot die at 220° C. at standard pressure. The roll pair was brought together so that the films (A1) and (A3) were contacted with the melt tail. The input amount of the melt tail was such that a layer (A2) of about 50 μm in thickness was formed between the polymer films (A1) and (A3). The roll pair had a temperature of 75° C. and the process speed was 15 m/min. The result was a trilayer laminate which was incapable of nondestructive separation. The film had a matte surface. The processing speed was able to be increased to different values which allowed a thickness of the film (A2) of up to 80 μm without changing the quality of the laminate. The input amount was likewise able to be reduced to about 40 μm without changing the quality of the laminate. As before, a good quality film with embedded security features was produced.

Results for various properties of some polymer films have been summarized in table 1.

TABLE 1

| | TPE film | Multilayer TPE film | | | 5GBP Banknote (n.i.) | |
|---|---|---|---|---|---|---|
| | Ex. 1 | Ex. 2 | Ex. 4 | Ex. 5 | Coated | Uncoated part |
| Tear propagation resistance | 280 | 284 | 275 | 131 | 18 | 21 |
| DIN 53363: 2003-10 [N/mm] | | | | | | |
| Light transmittance | 11 | 11 | 86 | 86 | 28.9 | 93.3 |
| ISO 13468-2 [%] | | | | | | |
| Stress at 10% elongation, | 20 | 30 | 30 | 30 | | |
| ISO 527-3 [MPa] | | | | | | |
| Surface energy | 38 | 38 | 38 | 38 | 41 | 30 |
| DIN ISO 8296 [mN/m] | | | | | | |
| Relaxation after creasing [mm/72 hours] | 1 | 1 | 1 | 5 | 5 | 5 |
| Nominal breaking elongation [%] | 39.1 | 182.4 | 200.1 | 164.6 | 40.7 | 36 |
| according to DIN EN ISO 527-3: 2019-02 | | | | | | |

The measurements on non-inventive banknotes were performed on 5 pound notes from Great Britain. As is apparent from table 1 the security documents (A) produced according to the invention from examples 2, 4 and 5 show an extremely high tear propagation resistance coupled with good relaxation characteristics after creasing, wherein 1 stands for creases protruding from a level base by at most 0.1 mm, 2 for 0.1 to 0.2 mm, 3 for 0.2 to 0.3 mm, 4 for 0.3 to 0.4 mm and 5 for 0.4 to 0.5 mm, good surface energies and variable adjustment of light transmittance. In this respect the non-inventive films made of BOPP do not show good tear propagation resistance even in coated form and can be made opaque only by a separate coating step. The creasing behaviour too is not as good as in the inventive examples. Example 1, i.e. the single-layer film made of TPU showed poor dimensional stability, since at identical elongation of 10% it already showed a markedly lower stress than the inventive examples Ex. 2, 4 and 5. This particularly positive characteristic is also reflected in the measured values of nominal breaking elongation which are four to five times higher for the inventive examples 2, 4 and 5 than for the non-inventive examples.

### FIGURES

FIGS. 1-2 describe preferred embodiments of the security document (A) and the process for production thereof which should not be considered limiting. In the figures:

FIG. 1: is a representation of a security document (A) in the form of a banknote but without a security feature (A4);

FIG. 2: is a schematic representation of the process for producing a security document (A) according to the invention.

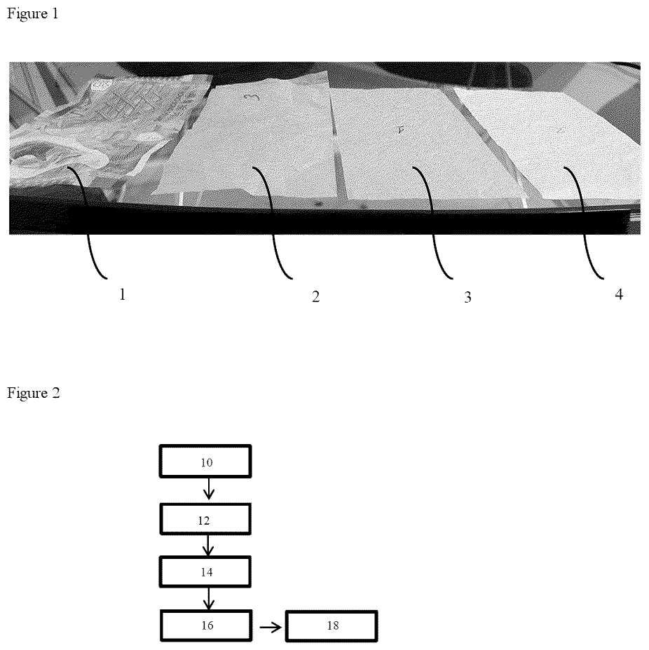

FIG. 1 shows a photo of 4 different banknotes. On the left side is a printed banknote 1 from the prior art in the form of a 10 Hong Kong Dollar banknote. On the right-hand side next to it is an unprinted banknote 2, i.e. a banknote substrate, composed of an extrudate of three layers, on the outside a TPU having a Shore hardness of 65D and in the core a TPU copolyester core having a Shore 85D hardness, this banknote substrate corresponding to example 5. To the right of banknote substrate 2 is an unprinted banknote substrate 3 made of an extrudate composed of three layers, on the outside a TPU having a Shore hardness of 65D and in the core a TPU having a Shore hardness of 85D, this banknote substrate corresponding to example 4. On the far right is an unprinted banknote substrate 4 made of an extrudate composed of three layers, on the outside a TPU having a Shore hardness of 65D with TiO₂ pigment and in the core a TPU having a Shore hardness of 85D with TiO₂ pigment, this banknote substrate corresponding to example 2. All banknotes/banknote substrates were subjected to a crease test. This comprised creasing the banknote by hand and then spreading it out on a smooth surface. After 72 h a visual assessment was carried out. It is clearly apparent that banknote substrate 2 has the fewest creases and behaves similarly to banknote 1 from the prior art. Banknote substrates 3 and 4 contain many fine creases and, while still exhibiting the bending characteristics typical of banknotes which make them easy to handle, have a less appealing hand feel than example 2.

FIG. 2 is a schematic diagram of the process for producing a security document (A). In step i) 10 a first polymer (A1′) was provided. In step ii) 12 a second polymer (A2′) was provided. The optional step iii) is not shown here. In step iv) 14 the polymers from step i) 10 and step ii) 12 were each melted in an extruder. Melting was carried out at a temperature of 250° C. and at standard pressure. In step v) 16 the polymer melts from step iv) were formed as a coextrudate by forming a first polymer film (A1) and a further polymer film (A3) from the first polymer (A1′) and a second polymer film (A2) from the second polymer (A2′). This was done by allowing the melts from the extruders to pass through a die onto two metal rolls. Parallel to the flow of the melts from the extruder in step vi) 18 a security thread was introduced between the melt of the polymer (A1′) and the melt of the polymer (A2′).

1: A security document (A) having a first outer surface (AS1) and a second outer surface (AS2) opposite the first outer surface (AS1) comprising at least:
(A1) a first polymer film (A1),
(A2) a second polymer film (A2),
(A3) optionally, at least one further polymer film (A3),
(A4) a security feature (A4),
(A5) optionally, fibres,
wherein at least one of the polymer films is selected from the group consisting of the first polymer film (A1), the second polymer film (A2), the at least one further polymer film (A3), a combination of at least two of these comprising a thermoplastic elastomer (TPE), and at least one TPE which forms at least one of the outer surfaces (AS1) or (AS2).

2: The security document (A) according to claim 1, wherein the TPE has a hardness in a range from 45 Shore D to 95 Shore D.

3: The security document (A) according to claim 1, wherein the TPE is selected from the group consisting of a thermoplastic polyamide elastomer, an olefin-based thermoplastic elastomer, a thermoplastic polyurethane (TPU), a copolyester elastomer, a polyether block amide, a copolyester, a polycarbonate, a polyethylene terephthalate (PET), a polyethylene terephthalate glycol (PETG) and a mixture of at least two of these.

4: The security document (A) according to claim 1, wherein the outer surfaces (AS1) and (AS2) of the security document (A) consist of polymer film (A1), (A2) or (A3) consisting of a TPU.

5: The security document (A) according to claim 1, wherein at least polymer films (A1), (A2) and (A3) consist of polymers, with the exception of the security feature (A4) and the fibres (A5).

6: The security document (A) according to claim 1, wherein the security document (A) comprises at least one further polymer film (A3), wherein the at least one further polymer film (A3) comprises TPE in an amount ranging from 50% to 100% by weight, based on the total weight of the respective polymer film (A3).

7: The security document (A) according to claim 1, wherein at least one of the polymer films selected from the group consisting of the first polymer film (A1), the second polymer film (A2) or both polymer films (A1) and (A2) comprises TPE in an amount in a range from 50% to 100% by weight, based on the total weight of the respective polymer film (A1) or (A2).

8: The security document (A) according to claim 1, wherein at least one of the polymer films selected from the group consisting of the first polymer film (A1), the second polymer film (A2) or both comprise a polymer selected from the group consisting of a thermoplastic polyurethane (TPU), a copolyester a mixture of at least two of these, mixtures of TPU and further TPEs in an amount in a range from 50% to 100% by weight, based on the total weight of the respective polymer film (A1) or (A2).

9: The security document (A) according to claim 1, wherein the security feature (A4) is selected from the group consisting of a hologram, a print, a security thread, a fluorescent fibre, a dye, a security pigment, carbon black, metallic or non-metallic micro- or nanoparticles, magnetic particles, an embossing, and a combination of at least two of these.

10: The security document (A) according to claim 1, wherein the security document (A) has at least one of the following properties:
a. a tear propagation resistance in a range from 50 N/mm to 400 N/mm determined according to DIN 53363:2003-10;
b. a tensile strength in a range from 20 MPa to 200 MPa determined according to ISO 527-3:1995;
c. a light transmittance in a range from 0% to 85% determined according to ISO 13468-2:2019;
d. a content of security pigments in a range from 0.1% to 10% by weight based on the total weight of the security document (A);
e. a crease recovery angle in a range from 120° to 170°, more preferably from 130° to 160°, according to DIN 53 890/91;
f. a Vicat softening temperature of 60° C. to 105° C., according to DIN EN ISO 306;
g. a nominal breaking elongation in a range from at least 60%, measured according to DIN EN ISO 527-1:2012.

11: A process for producing a security document (A) having a first outer surface (AS1) and a second outer surface (AS2) opposite the first outer surface (AS1) comprising the steps of:
i) providing a first polymer (A1′);
ii) providing a second polymer (A2′);
iii) optionally providing a further polymer (A3′);
iv) melting the polymers from step i), ii) and optionally iii);
v) either combining the polymer melts from step iv) to form a first polymer film (A1) from the first polymer (A1′), a second polymer film (A2) from the second polymer (A2′) and optionally a further polymer film (A3) from the first polymer (A1′) or from the further polymer (A3′) as a coextrudate or forming a laminate from in each case a separate polymer film (A1), (A2) and optionally (A3) formed from the melts in step iv);
vi) introducing a security feature (A4) selected from the group consisting of a hologram, a print, a security thread, a fluorescent fibre, a dye, a pigment, carbon black, metallic or non-metallic micro- or nanoparticles, magnetic particles, an embossing, and a combination of at least two of these into or onto one of the polymer films (A1), (A2) or (A3) to obtain the security document (A);
vii) optionally joining a polymer layer (A6) to one of the outer layers (AS1) or (AS2) over an area of at least 1 mm²,
wherein the outer surfaces (AS1) and (AS2) are formed by one of the polymer films (A1), (A2) or (A3) which each comprise or consist of a TPE.

12: The process according to claim 11, wherein at least one of the polymers selected from the group consisting of the polymer (A1′), the polymer (A2′), the polymer (A3′) is a polymer selected from the group consisting of a thermoplastic polyamide elastomer, an olefin-based thermoplastic elastomer, a thermoplastic styrene block copolymer, a thermoplastic polyurethane (TPU), a copolyester elastomer, a polyether block amide, a copolyester, a polycarbonate, a polyethylene terephthalate (PET), a polyethylene terephthalate glycol (PETG), and a mixture of at least two of these.

13: The process according to claim 11, wherein a further layer is applied to at least one surface (AS1) or (AS2) of the security document (A), wherein the further layer is a paper, a fibre composite, a textile or a combination of at least two of these.

14: One of a banknote, birth certificate, stamp, tax stamp, visa pages of a passport, hinge for the data page of a passport, carrier layer of an electromagnetic shielding in a passport comprising the security document according to claim 1.

15: One of a banknote, birth certificate, stamp, tax stamp, visa pages of a passport, hinge for the data page of a passport, carrier layer of an electromagnetic shielding in a passport comprising the security document produced by the process according to claim 11.
